(19) United States
(12) Patent Application Publication
(10) Pub. No.: US 2025/0336169 A1
(43) Pub. Date: Oct. 30, 2025

(54) METHOD, ELECTRONIC DEVICE, AND STORAGE MEDIUM FOR GROUP PHOTO INTERACTION BASED ON VIRTUAL IMAGE

(71) Applicant: TENCENT TECHNOLOGY (SHENZHEN) COMPANY LIMITED, Shenzhen (CN)

(72) Inventors: Yaohua YUE, Shenzhen (CN); Chenguang YANG, Shenzhen (CN); Wuhan ZHAO, Shenzhen (CN); Yasu WU, Shenzhen (CN); Ziyun LIU, Shenzhen (CN); Zixiang ZHAO, Shenzhen (CN); Jiayu CHEN, Shenzhen (CN); Ye LIU, Shenzhen (CN)

(21) Appl. No.: 19/257,212

(22) Filed: Jul. 1, 2025

Related U.S. Application Data
(63) Continuation of application No. PCT/CN2024/087995, filed on Apr. 16, 2024.

(30) Foreign Application Priority Data
Jun. 12, 2023 (CN) 202310691945.1

(51) Int. Cl. G06T 19/20

(52) U.S. Cl. CPC G06T 19/20; G06T 2219/2004

(57) ABSTRACT

A group photo interaction method includes: displaying a target group photo template including a first bearing position that bears a first virtual image corresponding to a current object and at least one second bearing position configured for bearing a virtual image corresponding to an invited interaction object; displaying impression information edited for the interaction object, the impression information being configured for indicating an impression of the current object for the interaction object; transmitting, in response to a group photo invitation operation for the interaction object, a group photo invitation bearing the impression information to a terminal corresponding to the interaction object; and displaying a second virtual image at a second bearing position in the target group photo template when the interaction object responds to the group photo invitation based on the impression information, and obtaining a target group photo including the first virtual image and the second virtual image.

### CROSS-REFERENCES TO RELATED APPLICATIONS

This application is a continuation application of PCT Patent Application No. PCT/CN2024/087995, filed on Apr. 16, 2024, which claims priority to Chinese Patent Application No. 202310691945.1, filed on Jun. 12, 2023, all of which are incorporated herein by reference in their entirety.

### FIELD OF THE TECHNOLOGY

The present disclosure relates to the field of mobile Internet technologies, and in particular, to a virtual image-based group photo interaction method and apparatus, a device, and a storage medium.

### BACKGROUND OF THE DISCLOSURE

With the development of mobile Internet technologies, in group photo application scenarios, the initiator of the group photo may invite a friend to participate in the group photo using virtual avatars/images, making the group photo more engaging. However, in existing technologies, the group photo initiator can only select a friend from a friend list or choose a friend photo locally, to invite the friend to participate in the group photo involving virtual avatars/images. The invited friend is completely in an unperceived or passive state and does not truly participate in the group photo, resulting in poor interactivity in the group photo experience.

### SUMMARY

One embodiment of the present disclosure provides a group photo interaction method based on virtual mage, performed by an electronic device. The method includes: displaying a target group photo template comprising a first bearing position and at least one second bearing position, the first bearing position bearing a first virtual image corresponding to a current object, and the second bearing position being configured for bearing a virtual image corresponding to an invited interaction object; displaying, in response to an information editing operation triggered based on the target group photo template, impression information edited for the interaction object, the impression information being configured for indicating an impression of the current object for the interaction object; transmitting, in response to a group photo invitation operation for the interaction object, a group photo invitation bearing the impression information to a terminal corresponding to the interaction object; and displaying a second virtual image at a second bearing position in the target group photo template when the interaction object responds to the group photo invitation based on the impression information, and obtaining a target group photo comprising the first virtual image and the second virtual image.

Another embodiment of the present disclosure provides an electronic device. The electronic device includes one or more processors and a memory containing a computer program that, when being executed, causes the one or more processors to perform: displaying a target group photo template comprising a first bearing position and at least one second bearing position, the first bearing position bearing a first virtual image corresponding to a current object, and the second bearing position being configured for bearing a virtual image corresponding to an invited interaction object; displaying, in response to an information editing operation triggered based on the target group photo template, impression information edited for the interaction object, the impression information being configured for indicating an impression of the current object for the interaction object; transmitting, in response to a group photo invitation operation for the interaction object, a group photo invitation bearing the impression information to a terminal corresponding to the interaction object; and displaying a second virtual image at a second bearing position in the target group photo template when the interaction object responds to the group photo invitation based on the impression information, and obtaining a target group photo comprising the first virtual image and the second virtual image.

Another embodiment of the present disclosure provides a non-transitory computer readable storage medium containing a computer program that, when being executed, causes at least one processor to perform: displaying a target group photo template comprising a first bearing position and at least one second bearing position, the first bearing position bearing a first virtual image corresponding to a current object, and the second bearing position being configured for bearing a virtual image corresponding to an invited interaction object; displaying, in response to an information editing operation triggered based on the target group photo template, impression information edited for the interaction object, the impression information being configured for indicating an impression of the current object for the interaction object; transmitting, in response to a group photo invitation operation for the interaction object, a group photo invitation bearing the impression information to a terminal corresponding to the interaction object; and displaying a second virtual image at a second bearing position in the target group photo template when the interaction object responds to the group photo invitation based on the impression information, and obtaining a target group photo comprising the first virtual image and the second virtual image.

### BRIEF DESCRIPTION OF THE DRAWINGS

FIG. 1 is a schematic architectural diagram of a virtual image-based group photo interaction system 100 according to an embodiment of the present disclosure.

FIG. 2 is a schematic structural diagram of an electronic device 500 according to an embodiment of the present disclosure.

FIG. 3 is a schematic flowchart of a virtual image-based group photo interaction method according to an embodiment of the present disclosure.

FIG. 4 is a schematic diagram showing a group photo template according to an embodiment of the present disclosure.

FIG. 5 is a schematic diagram of background changing of a group photo template according to an embodiment of the present disclosure.

FIG. 6 is a schematic diagram of editing impression information according to an embodiment of the present disclosure.

FIG. 7 is a schematic diagram of editing impression information according to an embodiment of the present disclosure.

FIG. 8 is a schematic diagram of editing a group photo theme according to an embodiment of the present disclosure.

FIG. 9 is a schematic diagram of editing a group photo template according to an embodiment of the present disclosure.

FIG. 10 is a schematic diagram of editing a group photo template according to an embodiment of the present disclosure.

FIG. 11 is a schematic diagram of an invitation of an interaction object according to an embodiment of the present disclosure.

FIG. 12 is a schematic diagram showing an invitation state according to an embodiment of the present disclosure.

FIG. 13 is a schematic diagram showing an invitation state according to an embodiment of the present disclosure.

FIG. 14 is a schematic diagram showing an invitation state according to an embodiment of the present disclosure.

FIG. 15 is a schematic diagram of a group photo invitation according to an embodiment of the present disclosure.

FIG. 16 is a schematic diagram of a group photo according to an embodiment of the present disclosure.

FIG. 17 is a schematic diagram of saving a group photo according to an embodiment of the present disclosure.

FIG. 18 is a schematic diagram of group photo details according to an embodiment of the present disclosure.

FIG. 19 is a schematic diagram of editing impression information according to an embodiment of the present disclosure.

FIG. 20 is a schematic diagram showing a target group photo according to an embodiment of the present disclosure.

FIG. 21 is a schematic diagram showing a target group photo according to an embodiment of the present disclosure.

FIG. 22 is a schematic diagram of sharing a target group photo according to an embodiment of the present disclosure.

FIG. 23 is a schematic architectural diagram of a virtual image-based group photo interaction system according to an embodiment of the present disclosure.

FIG. 24 is a schematic flowchart of a virtual image-based group photo interaction method according to an embodiment of the present disclosure.

FIG. 25 is a schematic diagram of synthesizing a target group photo according to an embodiment of the present disclosure.

### DESCRIPTION OF EMBODIMENTS

To make objectives, technical solutions, and advantages of the present disclosure clearer, the present disclosure is to be further described in detail with reference to accompany drawings. The described embodiments are not to be construed as a limitation on the present disclosure. All other embodiments obtained by a person of ordinary skill in the art without creative efforts fall within the protection scope of the present disclosure.

In the following description, the term “some embodiments” involved describes subsets of all possible embodiments, but “some embodiments” may be the same subset or different subsets of all the possible embodiments, and may be combined with each other without conflict.

In the following description, the term “first/second/ . . . ” involved is merely configured for distinguishing between similar objects and does not represent a specific order of objects. “first/second/ . . . ” may be transposed for a specific order or a sequence when allowed, so that the embodiments of the present disclosure described herein can be implemented in an order other than those illustrated or described herein.

Unless otherwise defined, meanings of all technical and scientific terms used herein are the same as those usually understood by a person skilled in the art to which the present disclosure belongs. The terms used in this specification are merely intended to describe objectives of the embodiments of the present disclosure, and are not intended to limit the present disclosure.

Before the embodiments of the present disclosure are further described in detail, terms involved in the embodiments of the present disclosure are described. The terms involved in the embodiments of the present disclosure are applicable to the following explanations.

1) Client: It is an application (APP) providing various services run in a terminal, for example, an instant messaging client, a social client, a photo client, and a short video client.

2) In response to: It is configured for indicating a condition or a state on which one or more to-be-performed operations rely. When the condition or the state is satisfied, the one or more operations may be performed in real time or have a set delay. Unless otherwise specified, an order in which a plurality of operations are performed is not limited.

The embodiments of the present disclosure provide a virtual image-based group photo method and apparatus, an electronic device, a computer-readable storage medium, and a computer program product, which can improve virtual image-based group photo interactivity. An exemplary application of the electronic device provided in the embodiments of the present disclosure is described below. The electronic device provided in the embodiments of the present disclosure may be implemented as various types of user terminals such as a notebook computer, a tablet computer, a desktop computer, a set-top box, a mobile device (for example, a mobile phone, a portable music player, a personal digital assistant, a dedicated messaging device, and a portable game device), a smart phone, a smart speaker, a smart watch, a smart television, an on-board terminal, an augmented reality (AR) device, and a virtual reality (VR) device, or may be implemented as a server. An exemplary application in which the electronic device is implemented as a terminal is described below.

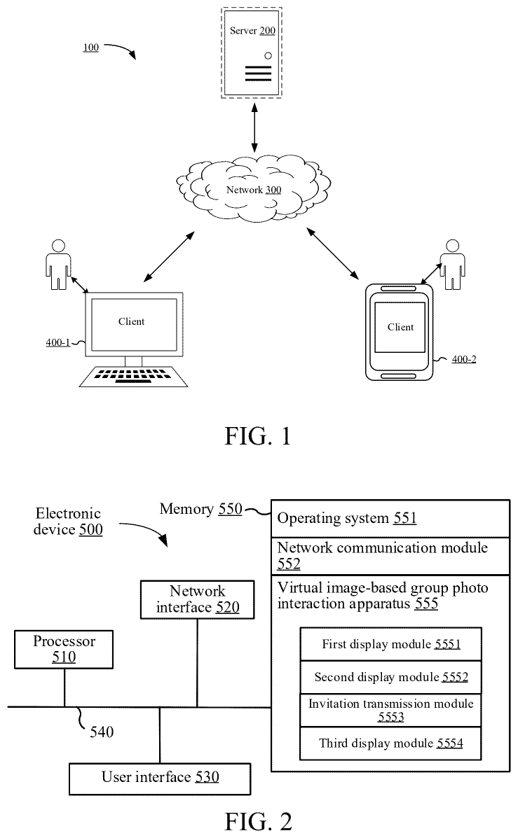

FIG. 1 is a schematic architectural diagram of a virtual image-based group photo interaction system 100 according to an embodiment of the present disclosure. To support an exemplary APP, a terminal (a terminal 400-1 and a terminal 400-2 that are exemplarily shown) is connected to a server 200 through a network 300. The network 300 may be a wide area network, a local area network, or a combination thereof.

In some embodiments, the terminal may be a smart phone, a tablet computer, a notebook computer, a desktop computer, a smart speaker, a smart watch, an on-board terminal, or the like, which is not limited thereto. A client having a virtual image-based group photo, such as an instant messaging client, a social client, a photo client, or a short video client, is installed on the terminal. The server 200 is a backend server corresponding to the client, may be an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a content delivery network (CDN), and a big data and artificial intelligence platform. The terminal 400 may be a smart phone, a tablet computer, a notebook computer, a desktop computer, a smart speaker, a smart watch, an on-board terminal, or the like, which is not limited thereto. The terminal and the server may be directly or indirectly connected in a manner of wired or wireless communication, which is not limited in the embodiments of the present disclosure.

In an actual application, an example in which the terminal 400-1 is a terminal on a side of a virtual image-based group photo initiator (i.e., a current object, or referred to as a group photo inviter), and the terminal 400-2 is a terminal on a side of a group photo invitee (i.e., an interaction object, when a plurality of invitees exist, 400-2 is a general term of the group photo invitees) is used. If the current object opens a client on the terminal 400-1 to initiate a virtual image-based group photo, the terminal 400-1 is configured to: display a target group photo template including a first bearing position and at least one second bearing position, the first bearing position bearing a first virtual image corresponding to a current object, and the second bearing position being configured for bearing a virtual image corresponding to an invited interaction object; display, in response to an information editing operation triggered based on the target group photo template, impression information for the interaction object obtained through editing; and transmit, in response to a group photo invitation operation for the interaction object, a group photo invitation bearing the impression information to the server 200. The server 200 is configured to forward the group photo invitation to the terminal 400-2 corresponding to the interaction object; and transmit response feedback to the server 200 when the interaction object responds to the group photo invitation based on the impression information through 400-2. The server 200 transmits the response feedback of the interaction object for responding to the group photo invitation to the terminal 400-1. When receiving the response feedback, the terminal 400-1 displays a second virtual image at the second bearing position in the target group photo template, to obtain a target group photo including the first virtual image and the second virtual image.

FIG. 2 is a schematic structural diagram of an electronic device 500 according to an embodiment of the present disclosure. An example in which the electronic device 500 is the terminal 400-1 in FIG. 1 is used. The electronic device 500 shown in FIG. 2 includes at least one processor 510, a memory 550, at least one network interface 520, and a user interface 530. Various assemblies in the electronic device 500 are coupled together through a bus system 540. The bus system 540 is configured to implement connection and communication between the assemblies. In addition to a data bus, the bus system 540 further includes a power bus, a control bus, and a status signal bus. However, for clarity of description, all types of buses in FIG. 2 are marked as the bus system 540.

The processor 510 may be an integrated circuit chip with a signal processing capability, for example, a general processor, a digital signal processor (DSP), another programmable logic device, a discrete gate or a transistor logic device, a discrete hardware component, or the like. The general processor may be a microprocessor, any suitable processor, or the like.

The memory 550 includes a volatile memory or a non-volatile memory, or may include both a volatile memory and a non-volatile memory. The non-volatile memory may be a read only memory (ROM), and the volatile memory may be a random access memory (RAM). The memory 550 described in the embodiments of the present disclosure is intended to include any suitable type of memory. In some embodiments, the memory 550 includes one or more storage devices physically away from the processor 510.

In some embodiments, the memory 550 can store data to support various operations. Examples of the data include a program, a module, and a data structure or a subset or a superset thereof. An exemplary description is provided below.

An operating system 551 includes system programs configured to process various basic system services and perform hardware-related tasks, for example, a framework layer, a core library layer, and a driver layer, which are configured for implementing various basic services and process hardware-based tasks. A network communication module 552 is configured to arrive at another electronic device through one or more (wired or wireless) network interfaces 520. Exemplary network interfaces 520 include Bluetooth, wireless fidelity (Wi-Fi), a universal serial bus (USB), and the like.

In some embodiments, a virtual image-based group photo interaction apparatus provided in the embodiments of the present disclosure may be implemented in a software manner. The virtual image-based group photo interaction apparatus provided in the embodiments of the present disclosure may be provided as various software embodiments, including various forms such as an APP, software, a software module, a script, or code. FIG. 2 shows a virtual image-based group photo interaction apparatus 555 stored in the memory 550, which may be software in a form of programs, plug-ins, and the like, including a series of modules. The modules include a first display module 5551, a second display module 5552, an invitation transmission module 5553, and a third display module 5554. The modules are logical. Therefore, the modules may be arbitrarily combined or further split based on to-be-implemented functions. Functions of the modules are described below.

In some other embodiments, the apparatus provided in the embodiments of the present disclosure may be implemented through hardware. In an example, the apparatus provided in the embodiments of the present disclosure may be a processor in the form of a hardware decoding processor, which is programmed to perform the virtual image-based group photo interaction method provided in the embodiments of the present disclosure. For example, the processor in the form of the hardware decoding processor may be one or more application specific integrated circuits (ASICs), a digital signal processor (DSP), a programmable logic device (PLD), a complex programmable logic device (CPLD), a field-programmable gate array (FPGA), or another electronic element.

In some embodiments, the terminal or the server may implement the virtual image-based group photo interaction method provided in the embodiments of the present disclosure by running various computer-executable instructions or computer programs. For example, the computer-executable instruction may be a microprogram-level command, a machine instruction, or a software instruction. For example, the computer program may be a native program or a software module in an operating system, may be a native APP, to be specific, a program that needs to be installed in the operating system to run, for example, an online education short video APP and a photo APP, or may be an applet that can be embedded into any APP, to be specific, a program that only needs to be downloaded into a browser environment to run. Based on the above, the foregoing computer-executable instruction may be an APP in any form. The foregoing computer program may be an APP, a module, or a plug-in of any form.

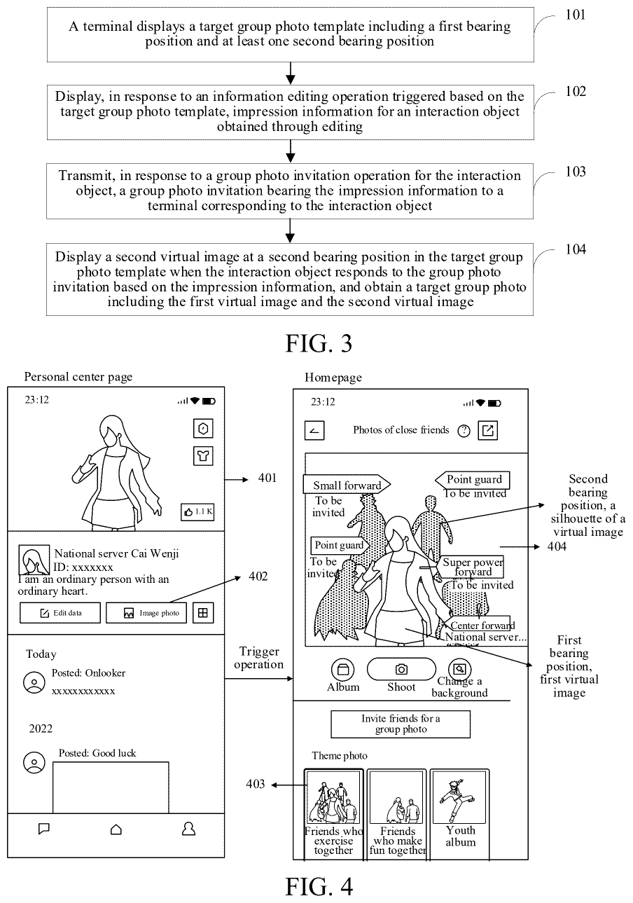

As described above, the virtual image-based group photo interaction method provided in the embodiments of the present disclosure may be implemented by various types of electronic devices, for example, which may be performed by the terminal in FIG. 1 alone, or may be performed collaboratively by the terminal and the server 200 in FIG. 1. Next, a description is provided by using an example in which the virtual image-based group photo interaction method provided in the embodiments of the present disclosure is performed by the terminal (the terminal on the side of the group photo initiator) in FIG. 1 alone. FIG. 3 is a schematic flowchart of a virtual image-based group photo interaction method according to an embodiment of the present disclosure. A description is provided with reference to operations shown in FIG. 3.

Operation 101: The terminal displays a target group photo template including a first bearing position and at least one second bearing position.

The first bearing position carries a first virtual image corresponding to a current object, and the second bearing position is configured for bearing a virtual image corresponding to an invited interaction object.

In some embodiments, the terminal may display the group photo template including the first bearing position and the at least one second bearing position in the following manners: displaying a virtual image group photo entrance on an information page of a current account; displaying at least one group photo template corresponding to the virtual image group photo in response to a trigger operation for the virtual image group photo entrance; and displaying a selected target group photo template in a group photo preview region in response to a template selection operation, the target group photo template including the first bearing position and the at least one second bearing position.

In an actual application, a client having a virtual image-based group photo function is installed on the terminal. The information page of the current account may be a setting page of the client to which the current account (i.e., the current object) logs in, such as a personal center page (i.e., a homepage), or may be an information flow page corresponding to the current object on the client. A virtual image group photo entrance configured to invoke the virtual image-based group photo function is displayed on the information page, and the group photo template of a used virtual image may be selected through the virtual image group photo entrance. An application scenario of this embodiment of the present disclosure is inviting the interaction object and the current object to make a group photo of virtual images. Therefore, the group photo template usually includes bearing positions for a plurality of virtual images. One bearing position is configured for bearing one virtual image. At least one of a quantity, a layout, and a background of each of the bearing positions corresponding to a different group photo template may different, and the current object may select a desired group photo template based on an actual requirement.

FIG. 4 is a schematic diagram showing a group photo template according to an embodiment of the present disclosure. A virtual image group photo entrance 402 (for example, a control such as an image photo) is displayed on a personal center page 401 of a client having a virtual image-based group photo function. A plurality of group photo templates that may be selected are displayed on a homepage of the client in response to a trigger operation for the virtual image group photo entrance 402. In view of a limitation of a view interface of a terminal, only some of the group photo templates are displayed on a current view interface, and a user may view more group photo templates by sliding left and right. When the user selects a target group photo template 403, a selected target group photo template 404 is displayed in a group photo preview region. A first bearing position and at least one second bearing position are displayed in the target group photo template 404. The first bearing position carries a first virtual image corresponding to a current object (i.e., the first virtual object corresponding to the current object is directly displayed in the first bearing position). The second bearing position is configured for bearing a virtual image corresponding to an interaction object that the current object needs to invite. Because the current object does not invite the interaction object, an actual virtual image is not displayed in the second bearing position, but a silhouette or an outline corresponding to the virtual image is displayed.

In an actual application, a quantity of the second bearing positions is determined based on a quantity of the virtual images in the target group photo template. For example, when the target group photo template includes 5 virtual images, bearing positions corresponding to 4 virtual images are remained in addition to the first bearing position occupied by the first virtual image corresponding to the current object. Therefore, the quantity of the second bearing positions is 4. In addition, the first virtual image corresponding to the current object may be displayed at a central position of the target group photo template by default. In other words, the first bearing position configured for bearing the first virtual image is a bearing position located in the target group photo template. Certainly, the first bearing position may alternatively be a bearing position located at another position in the target group photo template. A display position of the first bearing position is not limited in this embodiment of the present disclosure.

In some embodiments, the terminal may display the group photo template including the first bearing position and the at least one second bearing position in the following manners: displaying a target group photo template with a default background, the target group photo template including the first bearing position and the at least one second bearing position. Correspondingly, the terminal may change the background of the target group photo template in the following manners: displaying a background changing control corresponding to the target group photo template, the background changing control being configured to change the background of the target group photo template; and changing, in response to a background changing operation triggered based on the background changing control, the background of the target group photo template from the default background to a target background indicated in the background changing operation for changing.

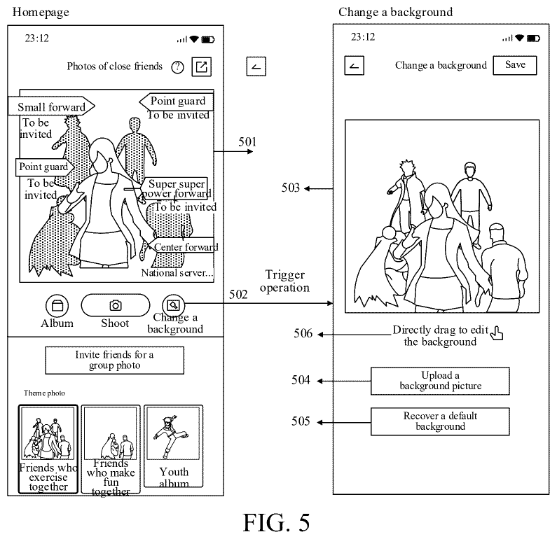

In an actual application, the target group photo template may have a corresponding default background, and the user may change the default background in the target group photo template of the group photo preview region through the background changing control. FIG. 5 is a schematic diagram of background changing of a group photo template according to an embodiment of the present disclosure. A target group photo template 501 with a default background is displayed in a group photo preview region of a homepage of a client, and a background changing control 502 of “Change a background” is displayed. A background changing page 503 is displayed in response to a trigger operation for the background changing control 502, and an “Upload a background picture” control 504 is displayed on the background changing page 503. A system album page may be invoked through the “Upload a background picture” control 504, so that the user selects a target picture from a system album as a target background, or shoots a target picture as the target background. In response to a confirmation operation (the confirmation operation is the background changing operation) for the target picture, the background of the target group photo template is changed from the default background to the target background (i.e., the target image) that the background changing operation instructs to change. In addition, a “Restore a default background” control 505 is further displayed on the background changing page 503, and a template of the target group photo template may be restored from the target background to the default background through the “restore a default background” control 505.

In an actual application, a terminal is configured to: display the background changing page in response to a trigger operation for the background changing control; display at least one candidate background (i.e., the candidate background is configured for the target group photo template on the background changing page when a system or operation personnel sets the target group photo template) corresponding to the target group photo template for selection, such as a candidate background 1 and a candidate background 2; and change, in response to a selection operation for the target background (for example, the candidate background 2), the background of the target group photo template from the default background to the target background (i.e., the candidate background).

In some embodiments, before the changing the background of the target group photo template from the default background to a target background indicated in the background changing operation for changing, the terminal may receive the background changing operation in the following manners: displaying a background preview interface in response to a trigger operation for the background changing control, and displaying a generated target background in the background preview interface, the target background corresponding to the current object and the interaction object; and receiving the background changing operation in response to a confirmation operation for the target background, the background changing operation instructing to change the background of the target group photo template from the default background to the target background.

In an actual application, the background changing control may be further configured to intelligently generate a target background to change the background of the target group photo template with an intelligently generated target background. For example, when the user triggers the background changing control, the terminal obtains a background generation reference factor in response to the trigger operation, intelligently conforms to the target backgrounds of the current object and the interaction object based on the background generation reference factor, and displays the generated target background in the background preview interface. If the current object is satisfied with the target background, the confirmation operation corresponding to the target background may be triggered. The terminal receives, in response to the trigger operation, the background changing operation configured for instructing to change the background of the target group photo template from the default background to the target background, and changes the background of the target group photo template from the default background to the target background in response to the background changing operation.

The background generation reference factor includes but is not limited to at least one of the following: an object feature of the current object, an object feature of the interaction object, and a social relationship between the current object and a target object. In this way, when the background is changed, the terminal intelligently generates the target background that adapted to the current object and the target object based on the background generation reference factor. As a result, when the current object transmits a group photo invitation to the interaction object, sentiments are better expressed and transmitted, deep interaction between the current object and the interaction object is promoted, thereby improving enthusiasm of a virtual image-based group photo.

In some embodiments, the terminal may further display a background editing control on the background changing page. The background editing control is configured to adjust a background parameter of the target group photo template, and the background parameter includes at least one of the following: a background size and a background orientation.

Still referring to FIG. 5, a background editing control 506 (for example, prompt information “Directly drag to edit the background” is used as the background editing control) may further be displayed on the background changing page 503. The background picture of the target group photo template is edited through the background editing control 506, for example, the background parameter of at least one of the background size and the background orientation is adjusted. During editing, the background picture of the target group photo template and the virtual image may be used as two layers. A layer on which the virtual image is located is fixed, and the user may zoom in, zoom out, or rotate the background picture through two fingers to adjust the background parameter.

In the foregoing manner, during group photo shooting, the background in the target group photo template may be customized and adjusted, thereby improving mobility and interaction diversity of the user during the group photo.

Operation 102: Display, in response to an information editing operation triggered based on the target group photo template, impression information for the interaction object obtained through editing.

The impression information is configured for indicating an impression of the current object for the interaction object.

In some embodiments, the terminal may display, in response to the information editing operation triggered based on the target group photo template, the impression information for the interaction object obtained through editing in the following manners: displaying a group photo editing control corresponding to the target group photo template; displaying a group photo editing page in response to a trigger operation for the group photo editing control, and displaying a first impression editing control in a target region corresponding to the second bearing position on the group photo editing page; and displaying, in response to an information editing operation triggered based on the first impression editing control, the impression information for the interaction object obtained through editing.

The first impression editing control is configured to edit impression information of the interaction object carried at the second bearing position. When a plurality of second bearing positions are provided in the target group photo template, each of the first impression editing controls may be displayed in the target region corresponding to each second bearing position on the group photo editing page, and impression information of the interaction object corresponding to a corresponding second bearing position is edited through each of the first impression editing controls. For example, if the target group photo template includes 1 first bearing position and 4 second bearing positions (a second bearing position 1 to a second bearing position 4), a first impression editing control 0 is displayed in an a region corresponding to the first bearing position on the group photo editing page, and a corresponding first impression editing control 1 to a first impression editing control 4 are displayed in a target region 1 to a target region 4 respectively corresponding to the second bearing position 1 to the second bearing position 4. Because editing manners of the impression information of the interaction objects corresponding to the bearing positions are consistent, a description is provided by using one second bearing position as an example.

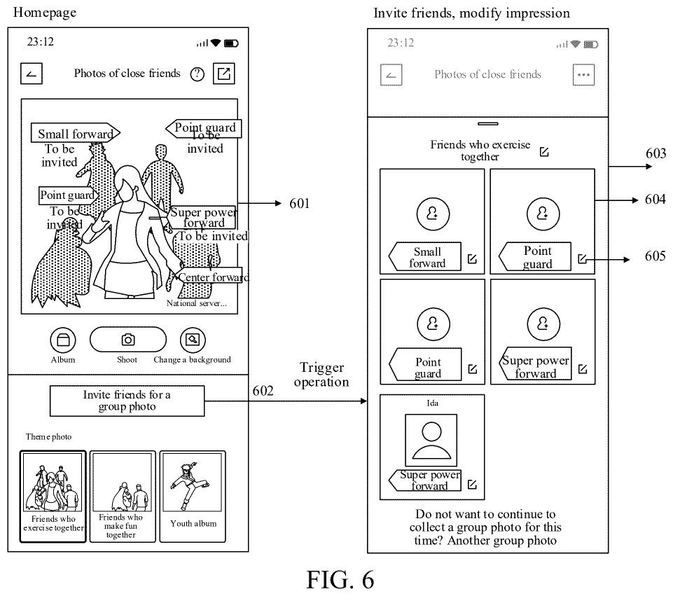

FIG. 6 is a schematic diagram of editing impression information according to an embodiment of the present disclosure. A group photo editing control 602 (for example, a control “Invite friends for a group photo”) configured to edit a target group photo template 601 displayed in a group photo preview region is displayed on a homepage of a client. A group photo editing page 603 is displayed in response to a trigger operation for the group photo editing control 602, and the first impression editing control is displayed in a region corresponding to each bearing position of the target group photo template 601 on the group photo editing page 603. For example, a first impression editing control 605 is displayed in a target region 604 corresponding to a second bearing position 1, and the impression information of the interaction object corresponding to the second bearing position 1 may be edited through the first impression editing control 605. For example, an impression information editing box is displayed in response to a trigger operation for the first impression editing control 605, and corresponding impression information obtained through editing may be input through an impression information editing box 606.

In the foregoing manner, the current object may customize and edit an impression of the interaction object. When the interaction object is invited to shoot a group photo, an impression evaluation of the current object for the interaction object is transmitted to the invited interaction object, so that the interaction object may determine whether to respond to the group photo invitation based on the impression information. During group photo shooting, deep interaction between the current object and the interaction object is promoted, sentiments are better expressed and transmitted, thereby improving enthusiasm of a virtual image-based group photo.

In some embodiments, the terminal may further display default impression information corresponding to the second bearing position in the target region, the default impression information being configured for indicating default impression carried in the target group photo template for the interaction object carried at the second bearing position. The terminal may display, in response to the information editing operation triggered based on the first impression editing control, the impression information for the interaction object obtained through editing in the following manners: displaying, in response to a trigger operation for the first impression editing control, an information modification page configured for modifying the default impression information; and displaying, in response to an information editing operation triggered based on the information modification page, the impression information for the interaction object obtained through modification of the default impression information.

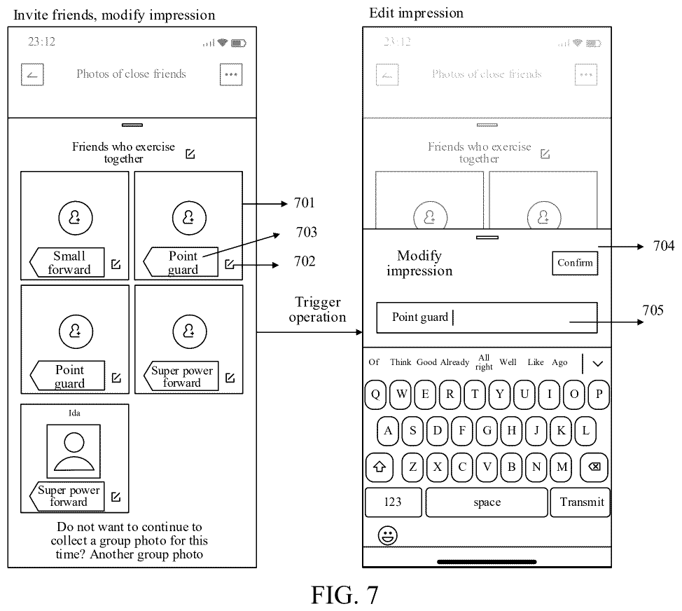

FIG. 7 is a schematic diagram of editing impression information according to an embodiment of the present disclosure. When a first impression editing control 702 is displayed in a target region 701 corresponding to a second bearing position, default impression information 703 is further displayed. An information modification page 704 is displayed in response to for trigger operation for the first impression editing control 702. Default impression information 705 in an editable state is displayed on the information modification page 704. Impression information for the interaction object obtained through editing the default impression information 706 is displayed in response to an information editing operation for the default impression information 705 in an editable state.

In the foregoing manner, editing and modification are performed based on the default impression information when the impression of the interaction object is customized and edited by the current object, which may improve convenience and efficiency of editing the impression information.

In some embodiments, the terminal may further display a default theme and a theme editing control corresponding to the target group photo template on the group photo editing page. The theme editing control is configured to edit the default theme, to obtain another theme.

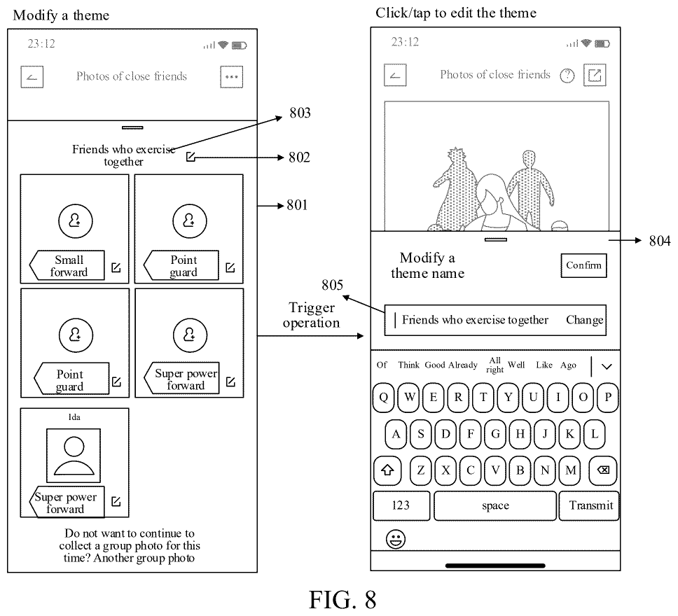

FIG. 8 is a schematic diagram of editing a group photo theme according to an embodiment of the present disclosure. A default theme 802 corresponding to a target group photo template and a theme editing control 803 are displayed on a group photo editing page 801. A theme modification page 804 is displayed in response to a trigger operation for the theme editing control 803. A default theme 805 in an editable state is displayed in the theme modification page 804. For example, the default theme is changed by clicking/tapping a “change” button to obtain another theme, or the default theme 805 in an editable state is modified and edited to obtain another theme in response to a theme editing operation on the default theme 805 in an editable state.

In the foregoing manner, during group photo shooting, the theme in the target group photo template may be customized and adjusted, thereby improving mobility and interaction diversity of the user during the group photo.

In some embodiments, before displaying the impression information for the interaction object obtained through editing, the terminal may receive the information editing operation in the following manners: controlling, in response to a trigger operation for the target group photo template, the target group photo template to be in an editable state; and receiving an information editing operation triggered based on the target group photo template in the editable state, the information editing operation at least instructing to edit the impression information of the interaction object carried at the second bearing position.

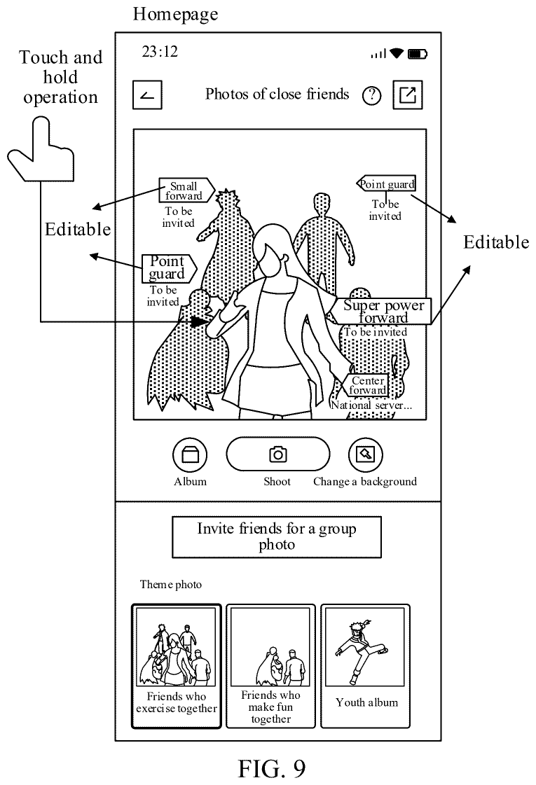

In an actual application, related information of the target group photo template may be directly edited in the group photo preview region. For example, FIG. 9 is a schematic diagram of editing a group photo template according to an embodiment of the present disclosure. The target group photo template is controlled to be in an editable state in response to a trigger operation (for example, a touch and hold operation, a click/tap operation, a slide operation, or an operation in another trigger form) on a target group photo template displayed in a group photo preview region. A theme of the target group photo template or the impression information of the interaction object corresponding to each bearing position in the target group photo template is edited through the target group photo template in an editable state. For example, an impression information editing box is displayed by each bearing position in the target group photo template in an editable state, and an information editing operation is triggered through the impression information editing box, to directly edit impression information of an interaction object corresponding to a corresponding bearing position.

In the foregoing manner, the current object may customize and edit an impression of the interaction object. When the interaction object is invited to shoot a group photo, an impression evaluation of the current object for the interaction object is transmitted to the invited interaction object, so that the interaction object may determine whether to respond to the group photo invitation based on the impression information. During group photo shooting, deep interaction between the current object and the interaction object is promoted, sentiments are better expressed and transmitted, thereby improving enthusiasm of a virtual image-based group photo.

In some embodiments, before displaying the impression information for the interaction object obtained through editing, the terminal may receive the information editing operation in the following manners: displaying a template editing control on the target group photo template, the template editing control being configured to edit at least one of the following information of the target group photo template: a theme of the target group photo template, a background of the target group photo template, and the impression information of the interaction object carried at the second bearing position; and receiving an information editing operation triggered based on the template editing control, the information editing operation at least instructing to edit the impression information of the interaction object carried at the second bearing position.

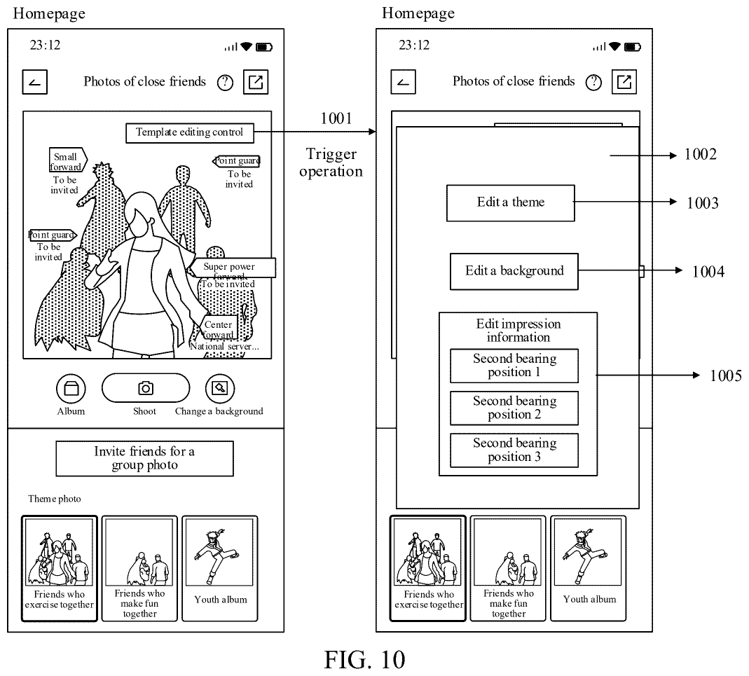

FIG. 10 is a schematic diagram of editing a group photo template according to an embodiment of the present disclosure. When related information of a target group photo template is directly edited in a group photo preview region, a template editing control 1001 may be displayed on the target group photo template. A template editing page 1002 is displayed in response to a trigger operation for the template editing control 1001. A sub-region 1003 configured to edit a theme of the target group photo template, a sub-region 1004 configured to edit a background of the target group photo template, and a sub-region 4005 configured to edit impression information of an interaction object carried in each second bearing position in the target group photo template may be displayed on the target editing page 1002. The related information of the target group photo template is edited through each sub-region.

In the foregoing manner, during group photo shooting, the related information of the target group photo template may be customized and edited, thereby improving mobility and interaction diversity of a user during the group photo.

Operation 103: Transmit, in response to a group photo invitation operation for the interaction object, a group photo invitation bearing the impression information to a terminal corresponding to the interaction object.

In some embodiments, before transmitting the group photo invitation bearing the impression information to the terminal corresponding to the interaction object, the terminal may receive the group photo invitation operation for the interaction object in the following manners: displaying a first object invitation control in the target region; displaying a selected interaction object in response to an object selection operation triggered based on the first object invitation control; and receiving, in response to a confirmation operation for the selected interaction object, a group photo invitation operation for the interaction object.

The first object invitation control is configured to invite the interaction object to join the second bearing position in the target group photo template to make a group photo of the virtual image. When a plurality of second bearing positions are provided in the target group photo template, each of the first object invitation controls may be displayed in the target region corresponding to each second bearing position on the group photo editing page, and the interaction object corresponding to the corresponding second bearing position is invited through each of first object invitation controls. For example, if the target group photo template has 4 second bearing positions (the second bearing position 1 to the second bearing position 4), a corresponding first object invitation control 1 to a first object invitation control 4 are displayed in a target region 1 to a target region 4 respectively corresponding to the second bearing position 1 to the second bearing position 4 on the group photo editing page. Because invitation manners of the interaction objects corresponding to the bearing positions are consistent, a description is provided by using one second bearing position as an example.

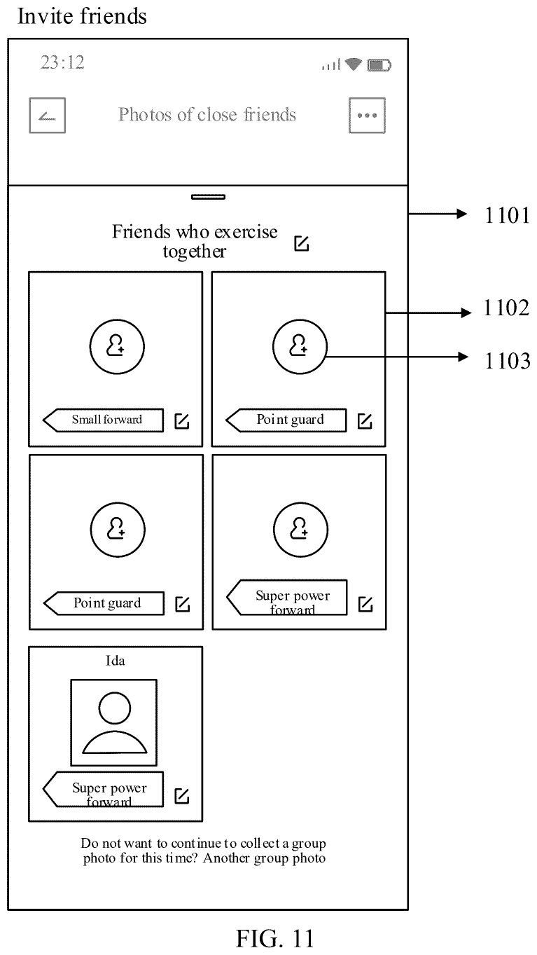

FIG. 11 is a schematic diagram of an invitation of an interaction object according to an embodiment of the present disclosure. A first object invitation control 1103 is displayed in a target region 1102 corresponding to a second bearing position 1 on a group photo editing page 1101. An interaction object corresponding to the second bearing position 1 may be invited through a first object invitation control 1103. For example, a plurality of candidate objects that may be selected, for example, a candidate object 1, a candidate object 2, and a candidate object 3, are displayed in response to a trigger operation for the first object invitation control 1103. The selected interaction object (for example, the candidate object 2) is displayed in response to an object selection operation. When the user clicks/taps a confirmation button, an object invitation operation for the interaction object (i.e., the candidate object 2) is received. A group photo invitation may be transmitted to a terminal corresponding to the interaction object (i.e., the candidate object 2).

In the foregoing manner, during group photo shooting, the current object may select an interaction object for the group photo, thereby improving pertinence of the user to perform group photo invitation for the object during the group photo.

In some embodiments, after transmitting the group photo invitation bearing the impression information to the terminal corresponding to the interaction object, the terminal may cancel the display of a first impression editing control in the target region, switch the first object invitation control displayed in the target region to display an invitation cancellation control, and display waiting indication information for the interaction object. The invitation cancellation control is configured to cancel the group photo invitation operation for the interaction object, and the waiting indication information is configured for instructing to wait for the interaction object to join the group photo and indicating waiting countdown for the interaction object.

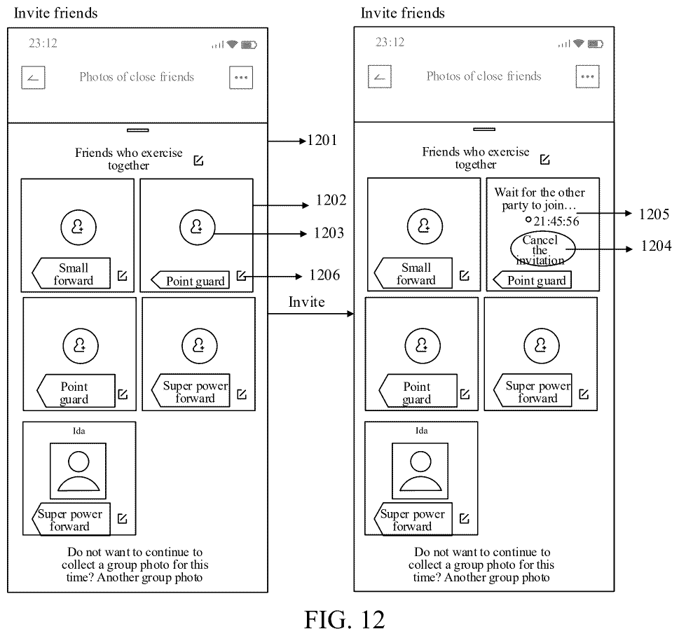

FIG. 12 is a schematic diagram showing an invitation state according to an embodiment of the present disclosure. After a group photo invitation is transmitted to a corresponding interaction object through a first object invitation control 1203 displayed in a target region 1202 corresponding to a second bearing position 1 on a group photo editing page 1201, the first object invitation control 1203 is switched to display an invitation cancellation control 1204. The group photo invitation for the interaction object may be cancelled through the invitation cancellation control 1204, and waiting indication information 1205 for the interaction object may be displayed in the target region, for example, waiting for the other party to join, or waiting countdown. The waiting countdown is configured for indicating an effective duration of the group photo invitation, and may be set based on an actual situation, for example, may be set to 24 hours. In other words, the group photo invitation is valid within 24 hours after the group photo invitation is transmitted, and the group photo invitation is invalid after 24 hours. In addition, a first impression editing control 1206 displayed in the target region 1202 may be controlled to disappear, or the first impression editing control 1206 may be controlled to be in an inoperable state. In other words, after the group photo invitation is transmitted, impression information of an invited interaction object cannot be edited again.

In the foregoing manner, after the group photo invitation is transmitted during group photo shooting, the current object is given a specific regret time. The current object is allowed to cancel and change an interaction object invited to join the group photo within the regret time, thereby further improving pertinence and wide applicability of the user to perform group photo invitation for the object during the group photo.

In some embodiments, the display of the waiting indication information and the invitation cancellation control are cancelled in the target region when the interaction object responds to the group photo invitation based on the impression information before the waiting countdown reaches zero, and an object identifier of the interaction object is displayed in the target region. The object identifier includes at least one of the following: an object avatar, an object account, and an object nickname.

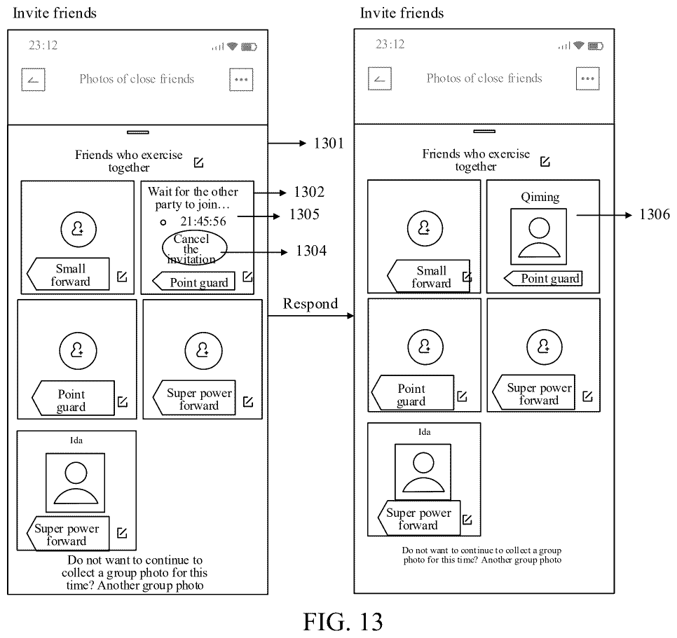

FIG. 13 is a schematic diagram showing an invitation state according to an embodiment of the present disclosure. After a group photo invitation is transmitted to a terminal of an interaction object, an invitation cancellation control 1304 and waiting indication information 1305 are displayed in a target region 1302 corresponding to a second bearing position 1 on a group photo editing page 1301. If the interaction object responds to the group photo invitation (for example, the interaction object triggers a confirmation operation for the group photo invitation) before the waiting countdown reaches zero, the display of the invitation cancellation control 1304 and the waiting indication information 1305 are cancelled in the target region 1302, and an object identifier 1306 of the interaction object, such as an object avatar and an object nickname, is displayed in the target region, to indicate that the interaction object is successfully invited.

In the foregoing manner, related information of more interaction objects is displayed. Therefore, increasingly diversified information obtaining requirements of users are met, and utilization of display resources of a terminal is also improved.

In some embodiments, the display of the waiting indication information is cancelled in the target region when the interaction object does not respond to the group photo invitation based on the impression information when the waiting countdown reaches zero; and displaying of the invitation cancellation control in the target region is switched to displaying of the first object invitation control, and displaying of the first impression editing control is recovered.

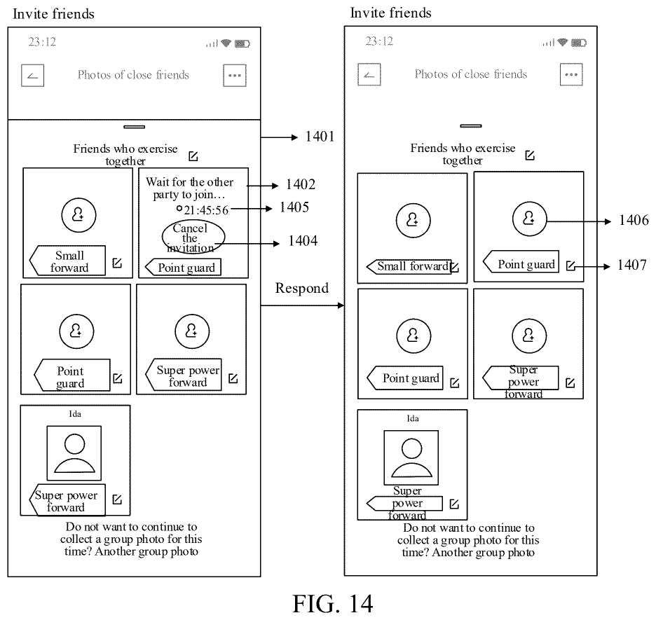

FIG. 14 is a schematic diagram showing an invitation state according to an embodiment of the present disclosure. After a group photo invitation is transmitted to a terminal of an interaction object, an invitation cancellation control 1404 and waiting indication information 1405 are displayed in a target region 1402 corresponding to a second bearing position 1 on a group photo editing page 1401. If the interaction object does not respond to the group photo invitation (for example, the interaction object triggers a rejection operation for the group photo invitation, or the interaction object does not trigger any operation for the group photo invitation) when the waiting countdown reaches zero, the display of the waiting indication information 1405 is cancelled in the target region 1402, the displayed cancel invitation cancellation control 1404 is switched to display a first object invitation control 1406, and displaying of a first impression editing control 1407 is recovered. The interaction object (which may be the same as or different from a previously invited interaction object) may be re-invited through the first object invitation control 1406, and impression information of the invited interaction object may be re-edited through the first impression editing control 1407. In this way, pertinence and wide applicability of user to perform the group photo invitation for the object during the group photo are further improved.

If the interaction object responds to the group photo invitation based on the impression information before the waiting countdown reaches zero, or the interaction object does not respond to the group photo invitation based on the impression information when the waiting countdown reaches zero, the group photo invitation displayed in the terminal corresponding to the interaction object becomes invalid. In other words, the interaction object cannot make a secondary response based on the group photo invitation after responding to interaction invitation within a specified time, or the interaction object cannot make a response based on the group photo invitation outside the specified time (in other words, after the waiting countdown reaches zero) after not responding to the interaction invitation within the specified time (i.e., before the waiting countdown reaches zero).

In some embodiments, the terminal may transmit the group photo invitation bearing the impression information to the terminal corresponding to the interaction object in the following manners: transmitting the group photo invitation bearing the impression information to the terminal corresponding to the interaction object in a target manner, the target manner including at least one of the following: an applet, a webpage link, and an electronic poster.

After the invited interaction object is determined, the interaction invitation may be transmitted in a plurality of transmitting manners. A display form of the interaction invitation may vary based on different transmitting manners. When the interaction invitation is transmitted through the applet, the terminal of the current object generates a group photo invitation applet as a group photo invitation based on the target group photo template and the impression information for the interaction object, and the group photo invitation applet is transmitted to the terminal of the interaction object, so as to display the group photo invitation applet on the terminal of the interaction object. A cover of the group photo invitation applet may be the target group photo template. When the interaction object triggers the group photo invitation applet, the terminal of the interaction object responds to the trigger operation. A corresponding group photo invitation applet is opened, the target group photo template, the impression information of the current object for the interaction object, and a response control are displayed through the group photo invitation applet, and the response to the interaction invitation is triggered through the response control triggering.

When the interaction invitation is transmitted through the webpage link, the terminal of the current object generates a corresponding group photo invitation link as a group photo invitation based on the target group photo template and the impression information for the interaction object, and the group photo invitation link is transmitted to the terminal of the interaction object, so as to display the group photo invitation link on the terminal of the interaction object. When the interaction object triggers the group photo invitation link, the terminal of the interaction object responds to the trigger operation. A corresponding group photo invitation web page is displayed, the target group photo template, the impression information of the current object for the interaction object, and the response control are displayed on the group photo invitation web page, and the response to the interaction invitation is triggered by triggering the response control.

When the interaction invitation is transmitted through the electronic poster, the terminal of the current object generates a corresponding group photo invitation link based on the target group photo template and the impression information for the interaction object, encodes the group photo invitation link, to obtain a graphic code corresponding to the group photo invitation link, generates a group photo invitation poster as the group photo invitation based on the graphic code, and transmits the group photo invitation poster to the terminal of the interaction object, so that the group photo invitation poster is displayed on the terminal of the interaction object. When receiving an identification operation for the graphic code, the terminal of the interaction object may open the corresponding group photo invitation applet. In addition, the target group photo template, the impression information of the current object for the interaction object, and the response control are displayed through the group photo invitation applet, and the response to the interaction invitation is triggered by triggering the response control.

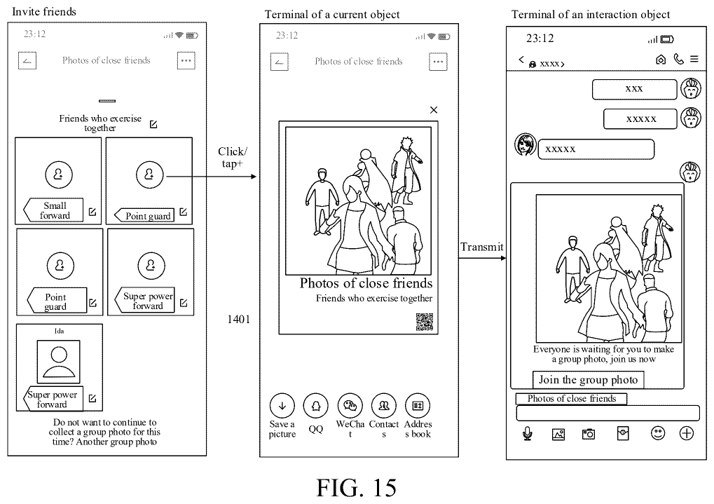

For example, FIG. 15 is a schematic diagram of a group photo invitation according to an embodiment of the present disclosure. The group photo invitation is transmitted to the terminal corresponding to the interaction object in a form of the electronic poster. When receiving the group photo invitation, the terminal of the interaction object may directly display the target group photo template, the impression information of the current object for the interaction object, and a response control for the group photo invitation poster when the group photo invitation poster is directly displayed in the terminal of the interaction object, to join the group photo after responding to the group photo invitation through the response control.

In the foregoing manner, the group photo invitation is transmitted to the interaction object in a plurality of manners, so that the group photo invitation may reach the interaction object as much as possible, thereby avoiding a group photo failure caused by omission of the group photo invitation by the interaction object, and improving a success rate of group photo interaction.

Operation 104: Display a second virtual image at a second bearing position in the target group photo template when the interaction object responds to the group photo invitation based on the impression information, and obtain a target group photo including the first virtual image and the second virtual image.

In some embodiments, after displaying the target group photo template including the first bearing position and the at least one second bearing position, the terminal displays a silhouette corresponding to the second virtual image in the second bearing position of the target group photo template. Correspondingly, the terminal may display the second virtual image at the second bearing position in the target group photo template in the following manner: switching displaying of the silhouette in the second bearing position to displaying of the second virtual object in the target group photo template.

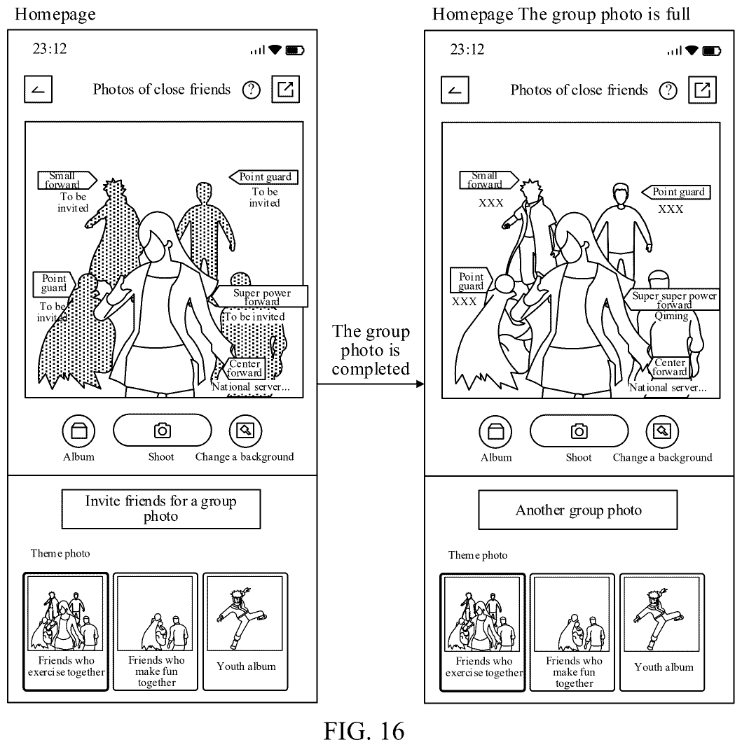

FIG. 16 is a schematic diagram of a group photo according to an embodiment of the present disclosure. Before a group photo invitation is transmitted to an interaction object, a first virtual image corresponding to a current object is displayed on a first bearing position of a target group photo template (i.e., a group photo initiator correspondingly automatically displays a corresponding virtual image on a bearing position of a target group photo template), and a silhouette (or an outline) corresponding to a second virtual object is displayed on a second bearing position of a to-be-invited interaction object. When responding to the group photo invitation, the interaction object switches the silhouette displayed on the second bearing position to display the second virtual image, to obtain a target group photo including the first virtual image and the second virtual image.

In the foregoing manner, when the interaction object accepts the group photo invitation, the target group photo that is successfully made is immediately displayed on the target group photo template, to intuitively reflect interactivity between the current object and the interaction object.

In some embodiments, after transmitting the group photo invitation bearing the impression information to a terminal corresponding to the interaction object, the terminal may save the target group photo template into a system album, and display a group photo progress of the target group photo template in the system album. After obtaining the target group photo including the first virtual image and the second virtual image, the terminal updates and displays the group photo progress of the target group photo template in the system album.

After the group photo invitation is transmitted to the terminal corresponding to the interaction object, the target group photo template invited with the interaction object may be automatically stored in the system album, the group photo progress of the target group photo template is displayed in the system album, and the group photo progress is updated with a response situation of the interaction object for the group photo invitation.

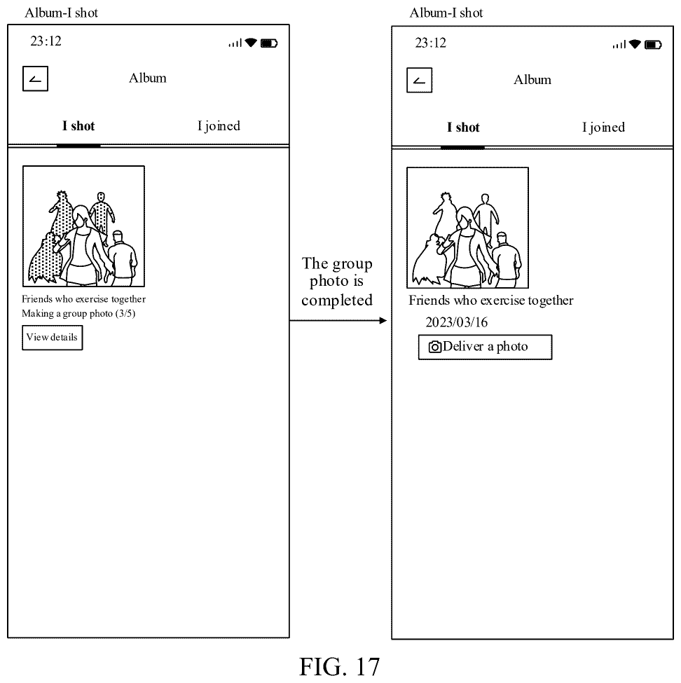

FIG. 17 is a schematic diagram of saving a group photo according to an embodiment of the present disclosure. A plurality of (for example, 4) second bearing positions are provided, and group photo invitations are transmitted to terminals corresponding to interaction objects corresponding to the 4 second bearing positions. 1 interaction object responds to the interaction invitations, and 3 interaction objects do not respond to the interaction invitations. In this case, a group photo progress may be displayed as (⅖, indicating that group photo completion is 40%) in a photo. If all of the 4 interaction objects respond to the interaction invitation, indication information indicating that the group photo is completed is displayed. For example, a control “Deliver a photo” is displayed, and time information indicating that the group photo is completed is displayed.

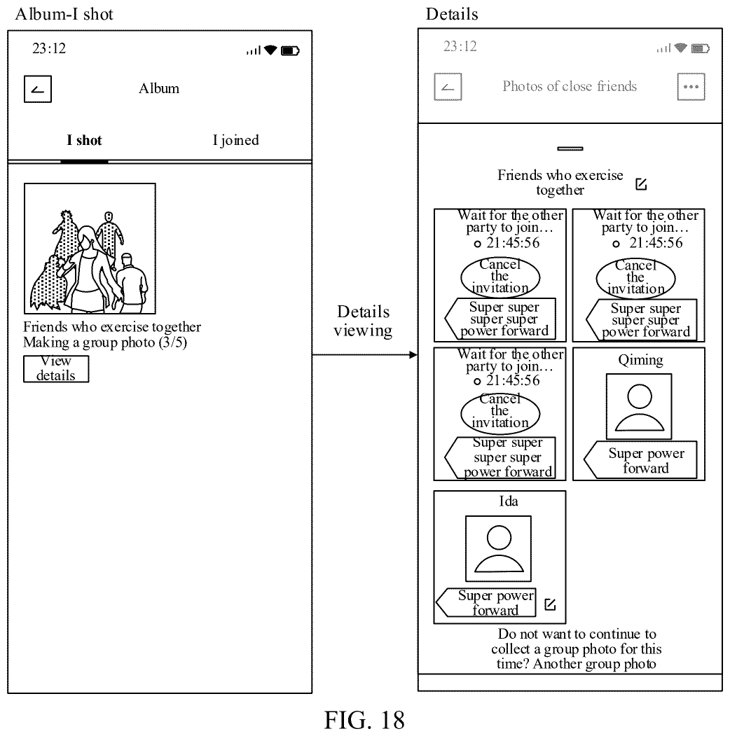

FIG. 18 is a schematic diagram of group photo details according to an embodiment of the present disclosure. If a group photo of a target group photo template stored in a system album is not completed, group photo detail information may be viewed through a detail viewing control. For example, a group photo detail page is displayed in response to a trigger operation for the detail viewing control, and a response situation for the interaction object corresponding to each second bearing position in the target group photo template for a group photo invitation is displayed in the group photo detail page. For example, an interaction object corresponding to a second bearing position 1 has responded to the group photo invitation, and interaction objects corresponding to second bearing positions 2 to 4 have not responded to the group photo invitation. In addition, invitation of the interaction object may be cancelled or the group photo may be ended in advance based on the group photo detail page.

In the foregoing manner, the group photo progress is displayed in real time during group photo shooting, so that the current object understands a real-time process of the group photo shooting, thereby improving experience of the group photo shooting.

In some embodiments, when a plurality of second bearing positions are provided, the terminal may display, in response to the information editing operation triggered based on the target group photo template, the impression information for the interaction object obtained through editing in the following manners: displaying a group photo editing page in response to a trigger operation for a group photo editing control corresponding to the target group photo template, and displaying a plurality of sub-regions and a second impression editing control on the group photo editing page, the sub-regions being in one-to-one correspondence with the second bearing positions, and the second impression editing control being configured to perform single-click/tap editing on impression information of interaction objects corresponding to the plurality of second bearing positions; displaying an impression editing page in response to a trigger operation for the second impression editing control, and displaying a plurality of information editing regions on the impression editing page; displaying, in each information editing region in response to an information editing operation triggered based on each information editing region, impression information obtained through editing for an interaction object corresponding to a corresponding second bearing position; and displaying, in each sub-region of the group photo editing page in response to a confirmation operation for each piece of impression information, the impression information for the interaction object corresponding to the corresponding second bearing position.

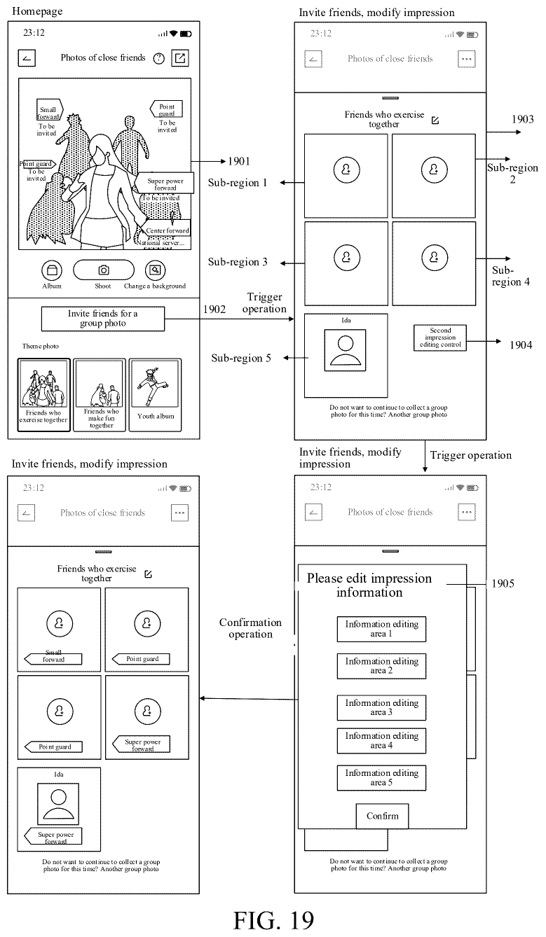

FIG. 19 is a schematic diagram of editing impression information according to an embodiment of the present disclosure. A group photo editing control 1902 (for example, a control “Invite friends for a group photo”) configured to edit a target group photo template 1901 displayed in a group photo preview region is displayed on a homepage of a client. A group photo editing page 1903 is displayed in response to a trigger operation on the group photo editing control 1902. sub-regions corresponding to a first bearing position and each second bearing position of the target group photo template 1901, such as a sub-region 1 to a sub-region 5, and a second impression editing control 1904 are displayed on the group photo editing page 1903. The second impression editing control 1904 is configured to perform single-click/tap editing on impression information corresponding to a plurality of sub-regions. For example, an impression editing page 1905 is displayed in response to a trigger operation for the second impression editing control 1904, and a plurality of information editing regions are displayed on the impression editing page, for example, an information editing region 1 for editing impression information corresponding to the sub-region 1, an information editing region 2 for editing impression information corresponding to the sub-region 2, an information editing region 3 for editing impression information corresponding to the sub-region 3, an information editing region 4 for editing impression information corresponding to the sub-region 4, and an information editing region 5 for editing impression information corresponding to the sub-region 5. In each information editing region, impression information corresponding to a corresponding sub-region is edited. After all editing is completed, a confirmation button is clicked. In other words, corresponding impression information may be displayed in the sub-regions of the group photo editing page. In this way, pertinence and convenience of impression information editing during group photo shooting may be improved.

In some embodiments, before transmitting the group photo invitation bearing the impression information to the terminal corresponding to the interaction object, the terminal is configured to: display a second object invitation control on the group photo editing page, the second object invitation control being configured to invite, through single click/tap, a plurality of interaction objects to join the second bearing position in the target group photo template to make a virtual image group photo; display a plurality of selected interaction objects in response to an object selection operation triggered based on the second object invitation control; and receive a group photo invitation operation for each interaction object in response to a confirmation operation for the plurality of selected interaction objects, and display an object identifier of a matching interaction object in each sub-region, a matching degree between the interaction object corresponding to the object identifier in each sub-region and impression information corresponding to the corresponding sub-region being higher than a matching degree threshold. Correspondingly, the terminal may transmit the group photo invitation bearing the impression information to a terminal corresponding to each interaction object.

When a plurality of second bearing positions are provided, the terminal may invite, through single click/tap, the interaction object of each second bearing position through the second object invitation control. After displaying a plurality of selected interaction objects in response to an object selection operation triggered based on the second object invitation control, the terminal may display a selection box corresponding to each sub-region, and display corresponding impression information in the selection box. The terminal may manually drag the selected interaction object to a selection box matching the impression information. For example, the terminal drags an interaction object 1 to a selection box corresponding to the impression information 1, drags an interaction object 2 to a selection box corresponding to the impression information 3, and so on. After dragging each selected interaction object to a matching selection box, and clicking the confirmation button, a group photo invitation operation for each interaction object may be received, an object identifier of a matching interaction object is displayed in each sub-region, and the group photo invitation is transmitted to the terminal corresponding to each interaction object. In this way, when a plurality of to-be-invited interaction objects exist, invitation efficiency for a plurality of interaction objects during group photo shooting can be improved.

In addition, after the terminal displays a plurality of selected interaction objects in response to the object selection operation triggered based on the second object invitation control, the terminal may further automatically obtain a matching degree between each interaction object and impression information corresponding to each sub-region (for example, calculate a similarity between an object feature of the interaction object and an information feature of the impression information), and display, in a corresponding sub-region, an object identifier corresponding to an interaction object whose matching degree is higher than a matching degree threshold. For example, if a matching degree between an interaction object 1 and impression information corresponding to the sub-region 1 is higher than a matching degree between the interaction object 1 and the impression information corresponding to another sub-region, the object identifier of the interaction object 1 is displayed in the sub-region 1. In other word, the interaction object 1 is invited to the second bearing position corresponding to the sub-region 1. In this way, single-click/tap editing is performed on the impression information of the plurality of interaction objects, thereby improving editing efficiency of the impression information. Impression information of to-be-invited interaction objects is intelligently displayed in a sub-region associated with a matching second bearing position, so that each impression information and a corresponding interaction object match with each other. When an interaction object is invited to shoot a group photo, impression evaluation of the current object for each interaction object is transmitted to the invited interaction object, so that each interaction object may determine whether to respond to the group photo invitation based on corresponding impression information. In this way, deep interaction between the current object and each interaction object is promoted during group photo shooting, sentiments are better expressed and transmitted, thereby improving enthusiasm of the virtual image-based group photo.

In some embodiments, a group photo updating control is displayed on the group photo editing page when some of the plurality of interaction objects respond to the group photo invitation base on the impression information, the group photo updating control being configured to stop the virtual image group photo collection based on the target group photo template, and start virtual image group photo recollection based on the target group photo template; and the target group photo template is reset in response to a group photo stop collection operation triggered based on the group photo updating control, and the obtained target group photo including the first virtual image and the second virtual images corresponding to some of the interaction objects is saved into a system album.

When the group photo collection is performed based on the target group photo template, if a plurality of invited interaction objects exist, but some of the interaction objects do not respond to the group photo invitation, the current object may stop, through the group photo updating control (if the current object does not want to continue to collect a group photo for this time, another group photo is shot), current group photo collection based on the target group photo template, and may start recollection of a next round of group photo. However, a target group photo template corresponding to the stopped group photo collection is automatically stored into the system album for the user to view. For example, a target group photo formed by second virtual images corresponding to some of the interaction objects that respond to the group photo invitation and a first virtual image corresponding to the current object is displayed in the target group photo template in the system album, and the background of the target group photo template is automatically transparently displayed at the second bearing position corresponding to the interaction object that do not respond to the group photo invitation in the target group photo template. For example, the target group photo template has 4 bearing positions, including 1 first bearing position (configured for bearing the first virtual image of the current object) and 3 second bearing positions stop the group photo collection at this time when the interaction object corresponding to 2 second bearing positions respond to the group photo invitation, the target group photo saved in the system album is a group photo formed by 1 first virtual image and second virtual images (i.e., 2 second virtual images) corresponding to 2 interaction objects that respond to the group photo invitation.

In some embodiments, when a plurality of second bearing positions are provided, a plurality of interaction objects are provided, and the interaction objects are in one-to-one correspondence with the second bearing positions. The terminal may implement displaying the second virtual image at the second bearing position in the target group photo template when the interaction object responds to the group photo invitation based on the impression information, and obtaining the target group photo including the first virtual image and the second virtual image in the following manners: displaying a corresponding second virtual images in each second bearing position in the target group photo template when the plurality of interaction objects all respond to the group photo invitation based on the impression information, and obtaining a target group photo including the first virtual image and the plurality of second virtual image.

When a plurality of second bearing positions are provided and an interaction object corresponding to each second bearing position responds to the group photo invitation, a corresponding second virtual image may be displayed on a vacant second bearing position in the target group photo template, so as to fill up the vacant bearing position in the target group photo template and obtain the target group photo including the first virtual image and the plurality of second virtual image.

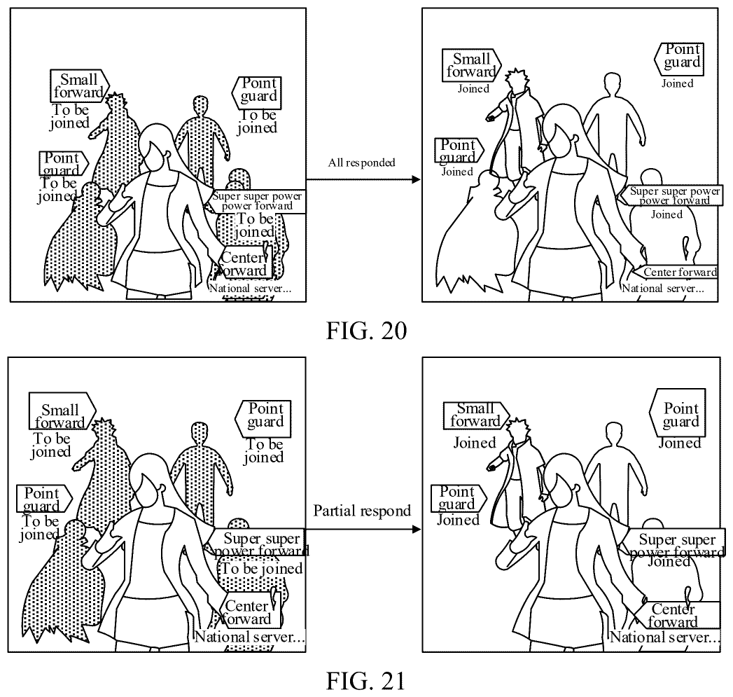

For example, FIG. 20 is a schematic diagram showing a target group photo according to an embodiment of the present disclosure. It is assumed that the target group photo template has 5 bearing positions. 1 first bearing position is configured for bearing a first virtual image of a current object, and 4 second bearing positions are configured for bearing virtual images corresponding to invited interaction objects. If the interaction objects corresponding to the 4 second bearing positions all respond to the group photo invitation, a finally obtained target group photo is a group photo formed by 1 first virtual image and second virtual images corresponding to the 4 interaction objects (i.e., 4 second virtual images). In other words, 5 virtual images exist in the target group photo in total. In this way, when the plurality of interaction objects all accept the group photo invitation, the target group photo including the virtual images of all the interaction objects is finally displayed, to intuitively reflect successful interactivity between the current object and each interaction object.

In some embodiments, when a first quantity of interaction objects in the plurality of interaction objects respond to the group photo invitation based on the impression information and a second quantity of interaction objects do not respond to the group photo invitation, corresponding second virtual images is displayed at second bearing positions corresponding to the first quantity of interaction objects in the target group photo template, and a background of the target group photo template is transparently displayed at second bearing positions corresponding to the second quantity of interaction objects, to obtain a target group photo including the first virtual object and the first quantity of second virtual images, a quantity of the interaction objects being a sum of the first quantity and the second quantity.

For example, FIG. 21 is a schematic diagram showing a target group photo according to an embodiment of the present disclosure. The target group photo template has 5 bearing positions. 1 first bearing position is configured for bearing the first virtual image of the current object, and 4 second bearing positions are configured for bearing virtual images corresponding to invited interaction objects. If interaction objects corresponding to 3 second bearing positions respond to the group photo invitation and 1 second bearing position is a corresponding interaction object that does not respond to the group photo invitation, a finally obtained target group photo is a group photo formed by 1 first virtual image and second virtual images corresponding to 3 interaction objects that respond to the group photo invitation (i.e., 3 second virtual images). However, the background of the target group photo template is automatically transparently displayed at the second bearing position corresponding to 1 interaction object that does not respond to the group photo invitation in the target group photo template. In other words, 4 virtual images exist in the target group photo in total. In this way, when individual interaction objects among the plurality of interaction objects do not accept the group photo invitation, only the virtual image of the interaction object that accepts the group photo invitation is displayed in the target group photo that is finally displayed, and the virtual image of the interaction object that does not accept the group photo invitation is not displayed, and the background in the second bearing position of the interaction object that does not accept the group photo invitation is transparently transmitted. In this way, not only the successful interactivity between the current object and the interaction object that accepts the group photo invitation is intuitively reflected, but also the target group photo is more real and non-contradictory.

In some embodiments, the terminal is configured to: display, on a sharing page in response to a sharing operation for the target group photo, group photo sharing information bearing the target group photo and a style switching control corresponding to the group photo sharing information, the style switching control being configured to switch the group photo sharing information between a sharing style of including description information and a sharing style of not including the description information, the description information including at least one of the following information for the current object and the interaction object in the target group photo: an object identifier and impression information; and share the group photo sharing information to a sharing object based on the sharing style corresponding to the style switching control.

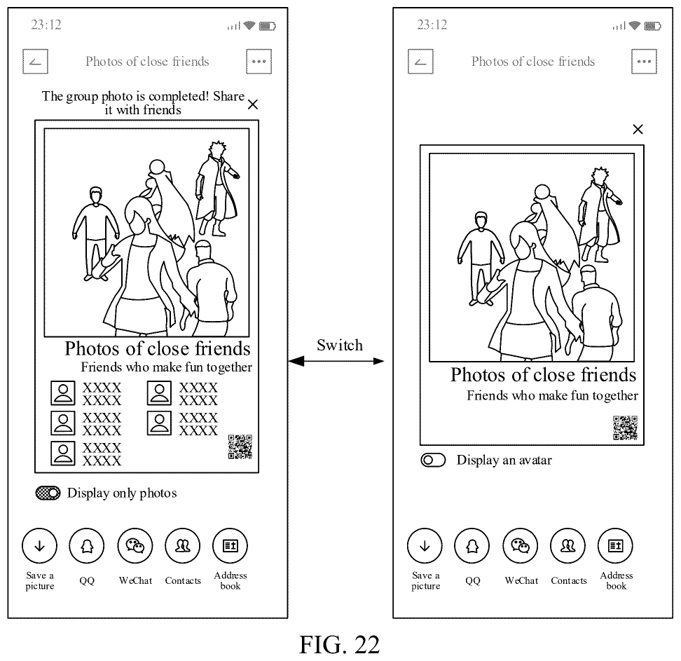

FIG. 22 is a schematic diagram of sharing a target group photo according to an embodiment of the present disclosure. When a target group photo is shared, a plurality of display styles of group photo sharing information may exist. For example, a first display style is that the group photo sharing information includes only the target group photo, and a second display style is that the group photo sharing information may further include, in addition to the target group photo, object identifiers (for example, avatars and nicknames) and impression information of a current object participating in the target group photo and all interaction objects. The two display styles may be switched through a style switching control. For example, (a) shows the first display style, and the style switching control is “Display only photos”. When a user clicks/taps the style switching control “Display only photos”, the first display style is switched to the second display style in (b). In addition, the style switching control is “Display an avatar”. In other words, the second display style shown in (b) may be switched to the first display style in (a) through clicking the style switching control “Display an avatar”.

In some embodiments, the terminal may display the target group photo template including the first bearing position and the at least one second bearing position in the following manner: displaying the target group photo template including the first bearing position and the at least one second bearing position in a video recording interface. Correspondingly, the terminal may obtain the target group photo including the first virtual image and the second virtual image in the following manner: controlling the first virtual object and the second virtual object in the target group photo template to synchronously move when the current object and the interaction object move, to obtain a target video formed by a plurality of frames of target group photo including the first virtual image and the second virtual image that synchronously move.

In an actual application, when the virtual image-based group photo interaction method is applied to a video shooting scenario, after the interaction object responds to the group photo invitation, no matter which of the current object and the interaction object moves, the first virtual object and the second virtual object in the target group photo template are controlled to synchronously move. In other words, a target video including the first virtual image and the second virtual image in moving changes is finally obtained. In this way, diversity of the interaction group photo is enriched.

In the embodiments of the present disclosure, relevant data such as user information (for example, a trigger operation of the user) is involved. When the embodiments of the present disclosure are applied to a specific product or technology, user permission or consent needs to be obtained, and acquiring, use, and processing of the relevant data need to comply with relevant laws, regulations, and standards of relevant countries and regions.

According to the foregoing manner, in virtual image-based group photo shooting, a group photo initiator (i.e., the current object) transmits the group photo invitation to a terminal of the interaction object. When the interaction object responds to the group photo invitation, a target group photo including the first virtual image corresponding to the current object and the second virtual image corresponding to the interaction object is obtained. In other words, the virtual image-based group photo can be successfully shot only when the invited interaction object responds to the group photo invitation, so that the invited interaction object really participates in the group photo shooting, thereby improving group photo interactivity of the virtual image. In addition, because the group photo invitation carries the impression information of the interaction object, in other words, when the interaction object is invited to shoot a group photo, an impression evaluation of the current object for the interaction object is transmitted to the invited interaction object, so that the interaction object may determine whether to respond to the group photo invitation based on the impression information. During group photo shooting, deep interaction between the current object and the interaction object is promoted, sentiments are better expressed and transmitted, thereby improving enthusiasm of a virtual image-based group photo.

Next, an exemplary application of the embodiments of the present disclosure in an actual application scenario is to be described.

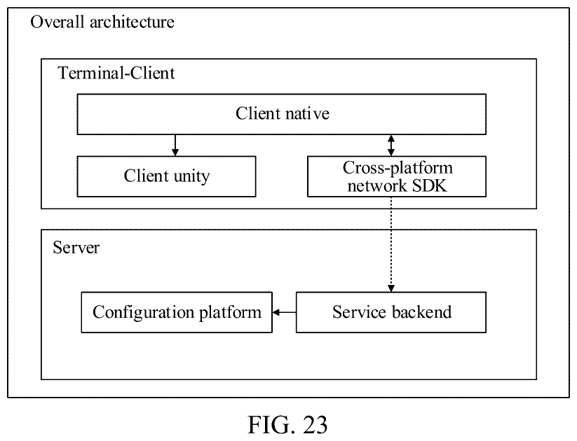

FIG. 23 is a schematic architectural diagram of a virtual image-based group photo interaction system according to an embodiment of the present disclosure. The system includes a terminal and a server. The terminal is provided with a client, including a client native, a client unity, and a cross-platform network software development kit (SDK). The client native refers to invoking a native interface part of an operating system on a terminal through a development language. For example, the native interface part of an Android system is invoked through kotlin of the Android system, and the native interface part of an iphone operation system (iOS) is invoked by using swift of the iOS system. This part is used as a client core hub to process the group photo template and group photo information. Group photo template information is stored on a configuration platform of the server, and the client invokes a service backend in the server through the cross-platform network SDK to read the group photo template information on the configuration platform.

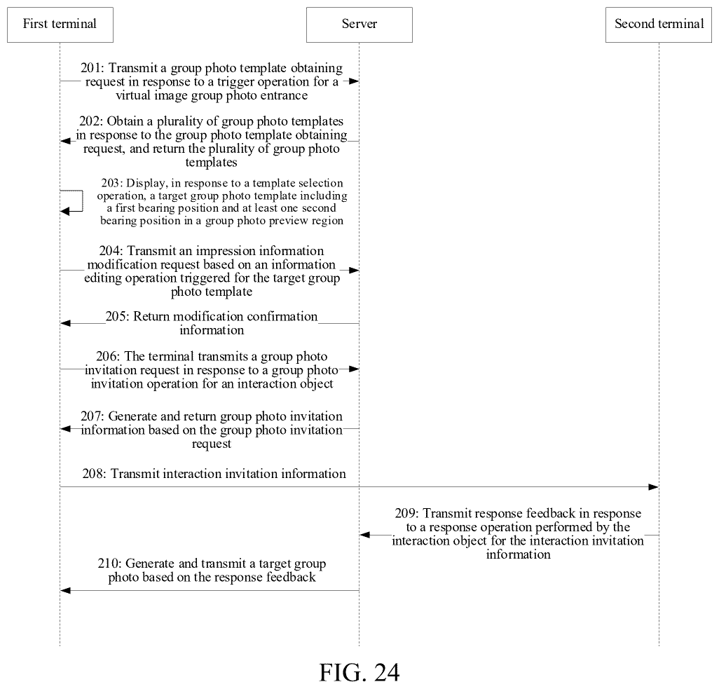

FIG. 24 is a schematic flowchart of a virtual image-based group photo interaction method according to an embodiment of the present disclosure. For example, the method is jointly implemented by a first terminal (a terminal of a group photo inviter, i.e., a terminal of a current object), a second terminal (a terminal of a group photo receiver, i.e., a terminal of an interaction object), and a server. The method includes the following operations.

Operation 201: The first terminal transmits a group photo template obtaining request to a server in response to a trigger operation for a virtual image group photo entrance.

A client having a virtual image-based group photo function is installed on the terminal. The virtual image group photo entrance configured to invoke the virtual image-based group photo function may be displayed on a setting page of the client, for example, a personal center page. When a current object (i.e., a group photo initiator) triggers the virtual image group photo entrance, the first terminal generates and transmits the group photo template obtaining request to the server in response to the trigger operation.

Operation 202: The server obtains a plurality of group photo templates in response to the group photo template obtaining request, and returns the plurality of group photo templates to the first terminal.

Operation 203: The first terminal displays, in response to a template selection operation, a target group photo template including a first bearing position and at least one second bearing position in a group photo preview region.

A plurality of group photo templates that may be selected are displayed on a homepage of the client in the first terminal. As shown in FIG. 4, in view of a limitation of the view interface of the terminal, only some of the group photo templates are displayed on a current view interface, and a user may view more group photo templates by sliding left and right. When the user selects a target group photo template, a selected target group photo template is displayed in the group photo preview region. The first bearing position and the at least one second bearing position are displayed in the target group photo template. The first virtual image corresponding to the current object is carried by the first bearing position (i.e., a corresponding first virtual object is directly displayed in the first bearing position). The second bearing position is configured for bearing the virtual image corresponding to the interaction object that the current object needs to invite. Because the interaction object has not joined the group photo, a corresponding virtual image is not displayed in the second bearing position, but a silhouette or an outline corresponding to the virtual image is displayed.

A quantity of the second bearing positions is determined based on a quantity of the virtual images in the target group photo template. For example, when the target group photo template includes 5 virtual images, bearing positions corresponding to 4 virtual images are remained in addition to the first bearing position occupied by the first virtual image corresponding to the current object. Therefore, the quantity of the second bearing positions is 4.

Operation 204: The first terminal transmits an impression information modification request to the server in response to an information editing operation triggered based on the target group photo template.

A group photo editing control (for example, a control “Invite friends for a group photo” shown in FIG. 6) configured to edit the target group photo template displayed in the group photo preview region is displayed on the homepage of the client of the first terminal. A group photo editing page is displayed in response to a trigger operation for the group photo editing control, and the impression editing control is displayed in a region corresponding to each bearing position of the target group photo template on the group photo editing page, so as to edit the impression information through the impression editing control.

One second bearing position is used as an example. As shown in FIG. 7, when a first impression editing control 702 is displayed in a target region 701 corresponding to a second bearing position, default impression information 703 (i.e., a default label) is further displayed. An information modification page 704 is displayed in response to a trigger operation for the first impression editing control 702. Default impression information 705 in an editable state is displayed on the information modification page 704. The impression information modification request is transmitted to the server in response to the information editing operation for the default impression information 705 in an editable state.

The impression information modification request carries default impression information to be modified and new impression information obtained after the modification, and is configured for requesting to modify the default impression information corresponding to the second bearing position into the new impression information.

Operation 205: The server returns modification confirmation information to a first terminal.

After allowing the default impression information to be modified, the server returns the modification confirmation information to the first terminal. After receiving the modification confirmation information, the first terminal may display modified impression information in the target region 701 corresponding to the second bearing position. The impression information is configured for indicating impression evaluation of the current object for the invited interaction object.

When a plurality of second bearing positions are provided, the impression information of the interaction object corresponding to each second bearing position may be edited or modified in the foregoing manner. Details are not described herein. In addition, information such as a theme and a background of the target group photo template displayed in the group photo preview region may further be modified. For a specific modification manner, reference is made to the foregoing embodiment. Details are not described herein again.

Operation 206: The first terminal transmits a group photo invitation request to the server in response to a group photo invitation operation for the interaction object.

When a plurality of second bearing positions are provided in the target group photo template, each of the first object invitation controls may be displayed in the target region corresponding to each second bearing position on the group photo editing page, and a group photo invitation is performed on the interaction object corresponding to the corresponding second bearing position through each of first object invitation controls. Because invitation manners of the interaction objects corresponding to the bearing positions are consistent, a description is provided by using one second bearing position as an example.

As shown in FIG. 11, the first object invitation control 1103 is displayed in the target region 1102 corresponding to the second bearing position 1 on the group photo editing page 1101. An interaction object corresponding to the second bearing position 1 may be invited through the first object invitation control 1103. For example, a plurality of candidate objects that may be selected, for example, the candidate object 1, the candidate object 2, and the candidate object 3, are displayed in response to the trigger operation for the first object invitation control 1103. The selected interaction object (for example, the candidate object 2) is displayed in response to the object selection operation. When the user clicks/taps the confirmation button, the group photo invitation request is transmitted to the server. The group photo invitation request is configured for inviting the interaction object (i.e., the candidate object 2) to join the group photo.

Operation 207: The server generates and returns group photo invitation information to the first terminal based on the group photo invitation request.

The group photo invitation information carries impression information of the current object for the interaction object.

Operation 208: The first terminal transmits interaction invitation information to the second terminal.

Operation 209: The second terminal transmits response feedback to the server in response to a response operation performed by the interaction object for the interaction invitation information.

Operation 210: The server generates and transmits the target group photo to the first terminal based on the response feedback.

When the interaction object responds to the interaction invitation, the second virtual image is displayed in the second bearing position, and the target group photo including the first virtual image and the second virtual image is generated.

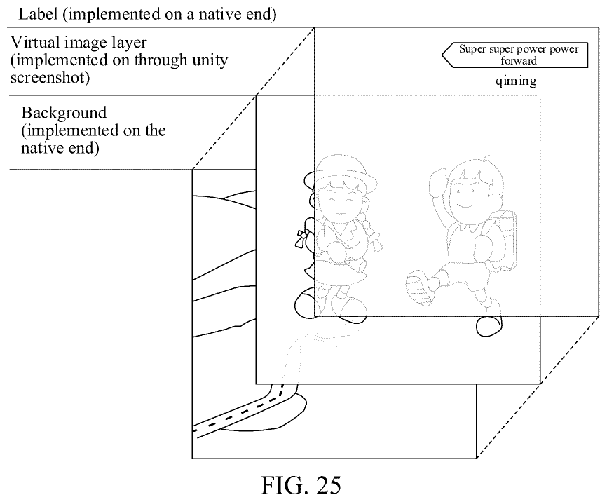

FIG. 25 is a schematic diagram of synthesizing a target group photo according to an embodiment of the present disclosure. In an actual application, to take both processing performance and flexibility into consideration, a process of synthesizing the target group photo includes a label layer, a virtual image layer, and a background layer. The label layer is configured for generating the impression information, and the background layer is configured for generating a group photo background. The two layers are implemented through a client native, and are implemented through a native interface part of an operating system on a terminal, which are more advantageous in two-dimensional interaction and can obtain a more natural two-dimensional interaction experience. The virtual image layer is a three-dimensional unity screenshot. The unity runs a three-dimensional scenario in a section of temporary internal memory invisible to a user, and is released after screenshot rendering ends, which can reduce occupation of an internal memory and a central processing unit or an image processing unit. In this way, with a combination of operation flexibility of the user and performance during running, a unity scenario does not need to be run in the whole process during a group photo, thereby effectively reducing a problem of terminal energy consumption caused by the three-dimensional scenario. However, various customization processing of the group photo is allowed to the user, thereby improving processing flexibility.

Certainly, in an actual application, the entire process of synthesizing the foregoing target group photo may be placed in the three-dimensional scenario, to improve an overall processing visual effect.

According to the foregoing manner, in virtual image-based group photo shooting, a group photo initiator (i.e., the current object) transmits the group photo invitation to a terminal of the interaction object. When the interaction object responds to the group photo invitation, a target group photo including the first virtual image corresponding to the current object and the second virtual image corresponding to the interaction object is obtained. In other words, the virtual image-based group photo can be successfully shot only when the invited interaction object responds to the group photo invitation, so that the invited interaction object really participates in the group photo shooting, thereby improving group photo interactivity of the virtual image. In addition, because the group photo invitation carries the impression information of the interaction object, in other words, when the interaction object is invited to shoot a group photo, an impression evaluation of the current object for the interaction object is transmitted to the invited interaction object, so that the interaction object may determine whether to respond to the group photo invitation based on the impression information. During group photo shooting, deep interaction between the current object and the interaction object is promoted, sentiments are better expressed and transmitted, thereby improving enthusiasm of a virtual image-based group photo.

At this point, with reference to the exemplary application and the implementation of the electronic device provided in the embodiments of the present disclosure, the virtual image-based group photo interaction method provided in the embodiments of the present disclosure is described. A virtual image-based group photo interaction solution through cooperation between modules in the virtual image-based group photo interaction apparatus 555 provided in the embodiments of the present disclosure is further described below.

The first display module 5551 is configured to display a target group photo template including a first bearing position and at least one second bearing position, the first bearing position bearing a first virtual image corresponding to a current object, and the second bearing position being configured for bearing a virtual image corresponding to an invited interaction object. The second display module 5552 is configured to display, in response to an information editing operation triggered based on the target group photo template, impression information for the interaction object obtained through editing, the impression information being configured for indicating an impression of the current object for the interaction object. The invitation transmission module 5553 is configured to transmit, in response to a group photo invitation operation for the interaction object, a group photo invitation bearing the impression information to a terminal corresponding to the interaction object. The third display module 5554 is configured to: display a second virtual image at a second bearing position in the target group photo template when the interaction object responds to the group photo invitation based on the impression information, and obtain a target group photo including the first virtual image and the second virtual image.

In some embodiments, the second display module is further configured to: display a group photo editing control corresponding to the target group photo template; display a group photo editing page in response to a trigger operation for the group photo editing control, and display a first impression editing control in a target region corresponding to the second bearing position on the group photo editing page; and display, in response to an information editing operation triggered based on the first impression editing control, the impression information for the interaction object obtained through editing.

In some embodiments, the apparatus further includes a default impression display module, which is configured to display default impression information corresponding to the second bearing position in the target region, the default impression information being configured for indicating default impression carried in the target group photo template for the interaction object carried at the second bearing position. The second display module is further configured to: display, in response to a trigger operation for the first impression editing control, an information modification page configured for modifying the default impression information; and display, in response to an information editing operation triggered based on the information modification page, the impression information for the interaction object obtained through modification of the default impression information.

In some embodiments, before the transmitting a group photo invitation bearing the impression information to a terminal corresponding to the interaction object, the apparatus further includes a first group photo invitation operation receiving module, which is configured to: display a first object invitation control in the target region, the first object invitation control being configured to invite the interaction object to join the second bearing position in the target group photo template to make a group photo of the virtual image; display a selected interaction object in response to an object selection operation triggered based on the first object invitation control; and receive, in response to a confirmation operation for the selected interaction object, a group photo invitation operation for the interaction object.

In some embodiments, after the transmitting a group photo invitation bearing the impression information to a terminal corresponding to the interaction object, the apparatus further includes an information update display module, which is configured to: cancel displaying the first impression editing control in the target region, switch displaying of the first object invitation control in the target region to displaying of an invitation cancellation control, and display waiting indication information for the interaction object, the invitation cancellation control being configured to cancel the group photo invitation operation for the interaction object, and the waiting indication information being configured for instructing to wait for the interaction object to join the group photo and indicating waiting countdown for the interaction object.

In some embodiments, the information update display module is further configured to: cancel displaying the waiting indication information and the invitation cancellation control in the target region when the interaction object responds to the group photo invitation based on the impression information before the waiting countdown reaches zero, and display an object identifier of the interaction object in the target region, the object identifier including at least one of the following: an object avatar, an object account, and an object nickname.

In some embodiments, the information update display module is further configured to: cancel displaying the waiting indication information in the target region when the interaction object does not respond to the group photo invitation based on the impression information when the waiting countdown reaches zero; and switch displaying of the invitation cancellation control in the target region to displaying of the first object invitation control, and recover displaying of the first impression editing control.

In some embodiments, the apparatus further includes a theme editing module, which is configured to display a default theme and a theme editing control corresponding to the target group photo template on the group photo editing page, the theme editing control being configured to edit the default theme, to obtain another theme.

In some embodiments, before the displaying impression information for the interaction object obtained through editing, the apparatus further includes a second group photo invitation operation receiving module, which is configured to: control, in response to a trigger operation for the target group photo template, the target group photo template to be in an editable state; and receive an information editing operation triggered based on the target group photo template in the editable state, the information editing operation at least instructing to edit the impression information of the interaction object carried at the second bearing position.

In some embodiments, before the displaying impression information for the interaction object obtained through editing, the apparatus further includes a third group photo invitation operation receiving module, which is configured to: display a template editing control on the target group photo template, the template editing control being configured to edit at least one of the following information of the target group photo template: a theme of the target group photo template, a background of the target group photo template, and the impression information of the interaction object carried at the second bearing position; and receive an information editing operation triggered based on the template editing control, the information editing operation at least instructing to edit the impression information of the interaction object carried at the second bearing position.

In some embodiments, the invitation transmission module is further configured to transmit the group photo invitation bearing the impression information to the terminal corresponding to the interaction object in a target manner, the target manner including at least one of the following: an applet, a webpage link, and an electronic poster.

In some embodiments, after the transmitting a group photo invitation bearing the impression information to a terminal corresponding to the interaction object, the apparatus further includes a group photo saving module, which is configured to save the target group photo template into a system album, and display group photo progress of the target group photo template in the system album. After the obtaining a target group photo including the first virtual image and the second virtual image, the apparatus further includes a progress update module, which is configured to update and display the group photo progress of the target group photo template in the system album.

In some embodiments, after the displaying a target group photo template including a first bearing position and at least one second bearing position, the apparatus further includes a silhouette display module, which is configured to display a silhouette corresponding to the second virtual image at the second bearing position of the target group photo template. The third display module is further configured to switch displaying of the silhouette in the second bearing position to displaying of the second virtual object in the target group photo template.

In some embodiments, when a plurality of second bearing positions are provided, the second display module is further configured to: display a group photo editing page in response to a trigger operation for a group photo editing control corresponding to the target group photo template, and display a plurality of sub-regions and a second impression editing control on the group photo editing page, the sub-regions being in one-to-one correspondence with the second bearing positions, and the second impression editing control being configured to perform single-click/tap editing on impression information of interaction objects corresponding to the plurality of second bearing positions; display an impression editing page in response to a trigger operation for the second impression editing control, and display a plurality of information editing regions on the impression editing page; display, in each information editing region in response to an information editing operation triggered based on each information editing region, impression information obtained through editing for an interaction object corresponding to a corresponding second bearing position; and display, in each sub-region of the group photo editing page in response to a confirmation operation for each piece of impression information, the impression information for the interaction object corresponding to the corresponding second bearing position.

In some embodiments, before the transmitting a group photo invitation bearing the impression information to a terminal corresponding to the interaction object, the apparatus further includes a fourth group photo invitation operation receiving module, which is configured to: display a second object invitation control on the group photo editing page, the second object invitation control being configured to invite, through single click/tap, a plurality of interaction objects to join the second bearing position in the target group photo template to make a virtual image group photo; display a plurality of selected interaction objects in response to an object selection operation triggered based on the second object invitation control; and receive a group photo invitation operation for each interaction object in response to a confirmation operation for the plurality of selected interaction objects, and display an object identifier of a matching interaction object in each sub-region, a matching degree between the interaction object corresponding to the object identifier in each sub-region and impression information corresponding to the corresponding sub-region being higher than a matching degree threshold. The invitation transmission module is further configured to transmit the group photo invitation bearing the impression information to a terminal corresponding to each interaction object.

In some embodiments, the apparatus further includes a photographing resetting module, which is configured to: display a group photo updating control on the group photo editing page when some of the plurality of interaction objects respond to the group photo invitation base on the impression information, the group photo updating control being configured to stop the virtual image group photo collection based on the target group photo template, and start virtual image group photo recollection based on the target group photo template; and reset the target group photo template in response to the group photo collection stop operation triggered based on the group photo updating control, and save the obtained target group photo including the first virtual image and the second virtual images corresponding to some of the interaction objects into a system album.

In some embodiments, when a plurality of second bearing positions are provided, a plurality of interaction objects are provided, and the interaction objects are in one-to-one correspondence with the second bearing positions. The third display module is further configured to display a corresponding second virtual image at each second bearing position of the target group photo template when the plurality of interaction objects all respond to the group photo invitation based on the impression information, and obtain the target group photo including the first virtual image and the plurality of second virtual images.

In some embodiments, the third display module is further configured to: display, when a first quantity of interaction objects in the plurality of interaction objects respond to the group photo invitation based on the impression information and a second quantity of interaction objects do not respond to the group photo invitation, corresponding second virtual images at second bearing positions corresponding to the first quantity of interaction objects in the target group photo template, and transparently display a background of the target group photo template at second bearing positions corresponding to the second quantity of interaction objects, to obtain a target group photo including the first virtual object and the first quantity of second virtual images, a quantity of the interaction objects being a sum of the first quantity and the second quantity.

In some embodiments, the apparatus further includes a group photo sharing module, which is configured to: display, on a sharing page in response to a sharing operation for the target group photo, group photo sharing information bearing the target group photo and a style switching control corresponding to the group photo sharing information, the style switching control being configured to switch the group photo sharing information between a sharing style of including description information and a sharing style of not including the description information, the description information including at least one of the following information for the current object and the interaction object in the target group photo: an object identifier and impression information; and share the group photo sharing information to a sharing object based on the sharing style corresponding to the style switching control.

In some embodiments, the first display module is further configured to display the target group photo template including the first bearing position and the at least one second bearing position in a video recording interface. The third display module is further configured to control the first virtual object and the second virtual object in the target group photo template to synchronously move when the current object and the interaction object move, to obtain a target video formed by a plurality of frames of target group photo including the first virtual image and the second virtual image that synchronously move.

In some embodiments, the first display module is further configured to: display a virtual image group photo entrance on an information page of a current account; display at least one group photo template corresponding to the virtual image group photo in response to a trigger operation for the virtual image group photo entrance; and display a selected target group photo template in a group photo preview region in response to a template selection operation, the target group photo template including the first bearing position and the at least one second bearing position.

In some embodiments, the first display module is further configured to display a target group photo template with a default background, the target group photo template including the first bearing position and the at least one second bearing position. The apparatus further includes a background changing module, which is configured to: display a background changing control corresponding to the target group photo template, the background changing control being configured to change the background of the target group photo template; and change, in response to a background changing operation triggered based on the background changing control, the background of the target group photo template from the default background to a target background indicated in the background changing operation for changing.

In some embodiments, before the changing the background of the target group photo template from the default background to a target background indicated in the background changing operation for changing, the apparatus further includes a changing operation receiving module, which is configured to: display a background preview interface in response to a trigger operation for the background changing control, and display a generated target background in the background preview interface, the target background corresponding to the current object and the interaction object; and receive the background changing operation in response to a confirmation operation for the target background, the background changing operation instructing to change the background of the target group photo template from the default background to the target background.

In some embodiments, the apparatus further includes a background editing module, which is configured to display a background editing control on the background changing page, the background editing control being configured to adjust a background parameter of the target group photo template, the background parameter including at least one of the following: a background size and a background orientation.

An embodiment of the present disclosure provides a computer program product, the computer program product including a computer program or a computer-executable instruction, the computer program or the computer-executable instruction being stored in a computer-readable storage medium. A processor of an electronic device reads the computer-executable instruction from the computer-readable storage medium. The processor executes the computer-executable instruction, so that the electronic device performs the foregoing virtual image-based group photo interaction method provided in the embodiments of the present disclosure.

An embodiment of the present disclosure provides a computer-readable storage medium having a computer-executable instruction stored therein, the computer-executable instruction or the computer program being stored, the computer-executable instruction or the computer program, when executed by a processor, causing the processor to perform the virtual image-based group photo interaction method provided in the embodiments of the present disclosure, for example, the virtual image-based group photo interaction method shown in FIG. 3.

The embodiments of the present disclosure have the following beneficial effects. By applying the embodiments of the present disclosure, in virtual image-based group photo shooting, a group photo initiator (i.e., the current object) transmits the group photo invitation to a terminal of the interaction object. When the interaction object responds to the group photo invitation, a target group photo including the first virtual image corresponding to the current object and the second virtual image corresponding to the interaction object is obtained. In other words, the virtual image-based group photo can be successfully shot only when the invited interaction object responds to the group photo invitation, so that the invited interaction object really participates in the group photo shooting, thereby improving group photo interactivity of the virtual image. In addition, because the group photo invitation carries the impression information of the interaction object, in other words, when the interaction object is invited to shoot a group photo, an impression evaluation of the current object for the interaction object is transmitted to the invited interaction object, so that the interaction object may determine whether to respond to the group photo invitation based on the impression information. During group photo shooting, deep interaction between the current object and the interaction object is promoted, sentiments are better expressed and transmitted, thereby improving enthusiasm of a virtual image-based group photo.

In some embodiments, the computer-readable storage medium may be a memory such as a ferromagnetic RAM (FRAM), a ROM, a programmable ROM (PROM), an erasable PROM (EPROM), an electrically EPROM (EEPROM), a flash memory, a magnetic surface memory, a compact disc, or a compact disc ROM (CD-ROM), or may be various devices including one of or any combination of the foregoing memories.

In some embodiments, the computer-executable instruction may be written in any form of a programming language (including a compiled or interpreted language, or a declarative or procedural language) in the form of a program, software, a software module, a script, or code, and may be deployed in any form, which may be deployed as a standalone program or as a module, components, a subroutine, or another unit suitable for use in a computing environment.

In an example, the computer-executable instruction may but may not necessarily correspond to a file in a file system, may be stored in a part of the file for storing other programs or data, for example, stored in one or more scripts in a hypertext markup language (HTML) document, stored in a single file specially used for the discussed program, or stored in a plurality of collaborative files (for example, files storing one or more modules, a subprogram, or a code part).

In an example, the computer-executable instruction may be deployed to be executed on one electronic device, on a plurality of electronic devices located at one site, or on a plurality of electronic devices distributed at a plurality of locations and connected by a communication network.

The foregoing descriptions are merely embodiments of the present disclosure and are not intended to limit the protection scope of the present disclosure. Any modification, equivalent replacement, or improvement made within the spirit and principle of the present disclosure falls within the protection scope of the present disclosure.

What is claimed is:

1. A group photo interaction method based on virtual mage, performed by an electronic device, and the method comprising:
displaying a target group photo template comprising a first bearing position and at least one second bearing position, the first bearing position bearing a first virtual image corresponding to a current object, and the second bearing position being configured for bearing a virtual image corresponding to an invited interaction object;
displaying, in response to an information editing operation triggered based on the target group photo template, impression information edited for the interaction object, the impression information being configured for indicating an impression of the current object for the interaction object;
transmitting, in response to a group photo invitation operation for the interaction object, a group photo invitation bearing the impression information to a terminal corresponding to the interaction object; and
displaying a second virtual image at a second bearing position in the target group photo template when the interaction object responds to the group photo invitation based on the impression information, and obtaining a target group photo comprising the first virtual image and the second virtual image.

2. The method according to claim 1, wherein displaying, in response to the information editing operation triggered based on the target group photo template, the impression information edited for the interaction object comprises:
displaying a group photo editing control corresponding to the target group photo template;
displaying a group photo editing page in response to a trigger operation for the group photo editing control, and displaying a first impression editing control in a target region associated with the second bearing position on the group photo editing page; and
displaying, in response to an information editing operation triggered based on the first impression editing control, the impression information for the interaction object obtained through editing.

3. The method according to claim 2, further comprising:
displaying default impression information corresponding to the second bearing position in the target region, the default impression information being configured for indicating default impression carried in the target group photo template for the interaction object carried at the second bearing position; and
displaying the impression information for the edited interaction object comprises:
displaying, in response to a trigger operation for the first impression editing control, an information modification page configured for modifying the default impression information; and
displaying, in response to an information editing operation triggered based on the information modification page, the impression information for the interaction object obtained through modification of the default impression information.

4. The method according to claim 2, further comprising:
displaying a first object invitation control in the target region, the first object invitation control being configured to invite the interaction object to join the second bearing position in the target group photo template to make a group photo of the virtual image; displaying a selected interaction object in response to an object selection operation triggered based on the first object invitation control; and receiving, in response to a confirmation operation for the selected interaction object, a group photo invitation operation for the interaction object, and
cancelling displaying the first impression editing control in the target region, switching displaying of the first object invitation control in the target region to displaying of an invitation cancellation control, and displaying waiting indication information for the interaction object,
the invitation cancellation control being configured to cancel the group photo invitation operation for the interaction object, and the waiting indication information being configured for instructing to wait for the interaction object to join the group photo and indicating waiting countdown for the interaction object.

5. The method according to claim 4, further comprising:
cancelling displaying the waiting indication information and the invitation cancellation control in the target region when the interaction object responds to the group photo invitation based on the impression information before the waiting countdown reaches zero, and
displaying an object identifier of the interaction object in the target region, the object identifier comprising at least one of the following: an object avatar, an object account, and an object nickname.

6. The method according to claim 4, further comprising:
cancelling displaying the waiting indication information in the target region when the interaction object does not respond to the group photo invitation based on the impression information when the waiting countdown reaches zero; and
switching displaying of the invitation cancellation control in the target region to displaying of the first object invitation control, and recovering displaying of the first impression editing control.

7. The method according to claim 2, further comprising:
displaying a default theme and a theme editing control corresponding to the target group photo template on the group photo editing page,
the theme editing control being configured to edit the default theme, to obtain another theme.

8. The method according to claim 1, further comprising:
controlling, in response to a trigger operation for the target group photo template, the target group photo template to be in an editable state; and
receiving an information editing operation triggered based on the target group photo template in the editable state, the information editing operation at least instructing to edit the impression information of the interaction object carried at the second bearing position.

9. The method according to claim 1, further comprising:
displaying a template editing control on the target group photo template, the template editing control being configured to edit at least one of the following information of the target group photo template: a theme of the target group photo template, a background of the target group photo template, and the impression information of the interaction object carried at the second bearing position; and
receiving an information editing operation triggered based on the template editing control, the information editing operation at least instructing to edit the impression information of the interaction object carried at the second bearing position.

10. The method according to claim 1, wherein transmitting the group photo invitation bearing the impression information to the terminal corresponding to the interaction object comprises:
transmitting the group photo invitation bearing the impression information to the terminal corresponding to the interaction object in a target manner,
the target manner comprising at least one of the following: an applet, a webpage link, and an electronic poster.

11. The method according to claim 1, further comprising:
saving the target group photo template into a system album, and displaying group photo progress of the target group photo template in the system album; and
updating and displaying the group photo progress of the target group photo template in the system album.

12. The method according to claim 1, further comprising:
displaying a silhouette corresponding to the second virtual image at the second bearing position of the target group photo template; and
displaying the second virtual image at the second bearing position in the target group photo template comprises:
switching displaying of the silhouette in the second bearing position to displaying of the second virtual object in the target group photo template.

13. The method according to claim 1, wherein when a plurality of second bearing positions are provided, displaying, in response to the information editing operation triggered based on the target group photo template, the impression information edited for the interaction object comprises:
displaying a group photo editing page in response to a trigger operation for a group photo editing control corresponding to the target group photo template, and displaying a plurality of sub-regions and a second impression editing control on the group photo editing page,
the plurality of sub-regions being in one-to-one correspondence with the plurality of second bearing positions, and the second impression editing control being configured to perform single-click/tap editing on impression information of interaction objects corresponding to the plurality of second bearing positions;
displaying an impression editing page in response to a trigger operation for the second impression editing control, and displaying a plurality of information editing regions on the impression editing page;
displaying, in each information editing region in response to an information editing operation triggered based on each information editing region, impression information obtained through editing for an interaction object corresponding to a corresponding second bearing position; and
displaying, in each sub-region of the group photo editing page in response to a confirmation operation for each piece of impression information, the impression information for the interaction object corresponding to the corresponding second bearing position.

14. The method according to claim 13, further comprising:
displaying a second object invitation control on the group photo editing page, the second object invitation control being configured to invite, through single click/tap, a plurality of interaction objects to join the second bearing position in the target group photo template to make a virtual image group photo;
displaying a plurality of selected interaction objects in response to an object selection operation triggered based on the second object invitation control; and
receiving a group photo invitation operation for each interaction object in response to a confirmation operation for the plurality of selected interaction objects, and displaying an object identifier of a matching interaction object in each sub-region,
a matching degree between the interaction object corresponding to the object identifier in each sub-region and impression information corresponding to the corresponding sub-region being higher than a matching degree threshold; and
transmitting the group photo invitation bearing the impression information to a terminal corresponding to the interaction object comprises:
transmitting the group photo invitation bearing the impression information to a terminal corresponding to each interaction object.

15. The method according to claim 14, further comprising:
displaying a group photo updating control on the group photo editing page when some of the plurality of interaction objects respond to the group photo invitation base on the impression information,
the group photo updating control being configured to stop the virtual image group photo collection based on the target group photo template, and start virtual image group photo recollection based on the target group photo template; and
resetting the target group photo template in response to the group photo collection stop operation triggered based on the group photo updating control, and saving the obtained target group photo comprising the first virtual image and the second virtual images corresponding to some of the interaction objects into a system album.

16. The method according to claim 1, wherein when a plurality of second bearing positions are provided, a plurality of interaction objects are provided, and the interaction objects are in one-to-one correspondence with the second bearing positions; and
displaying the second virtual image at the second bearing position in the target group photo template when the interaction object responds to the group photo invitation based on the impression information, and obtaining the target group photo comprising the first virtual image and the second virtual image comprises:
displaying a corresponding second virtual image at each second bearing position of the target group photo template when the plurality of interaction objects all respond to the group photo invitation based on the impression information, and obtaining the target group photo comprising the first virtual image and the plurality of second virtual images,
wherein the method further comprises: displaying, when a first quantity of interaction objects in the plurality of interaction objects respond to the group photo invitation based on the impression information and a second quantity of interaction objects do not respond to the group photo invitation, corresponding second virtual images at second bearing positions corresponding to the first quantity of interaction objects in the target group photo template, and
transparently displaying a background of the target group photo template at second bearing positions corresponding to the second quantity of interaction objects, to obtain a target group photo comprising the first virtual object and the first quantity of second virtual images,
a quantity of the interaction objects being a sum of the first quantity and the second quantity; and
wherein the method further comprises: displaying, on a sharing page in response to a sharing operation for the target group photo, group photo sharing information bearing the target group photo and a style switching control corresponding to the group photo sharing information,
the style switching control being configured to switch the group photo sharing information between a sharing style of comprising description information and a sharing style of not comprising the description information, the description information comprising at least one of the following information for the current object and the interaction object in the target group photo: an object identifier and impression information; and
sharing the group photo sharing information to a sharing object based on the sharing style corresponding to the style switching control.

17. The method according to claim 1, wherein displaying the target group photo template comprising the first bearing position and the at least one second bearing position comprises:
displaying the target group photo template comprising the first bearing position and the at least one second bearing position in a video recording interface; and obtaining the target group photo comprising the first virtual image and the second virtual image comprises: controlling the first virtual object and the second virtual object in the target group photo template to synchronously move when the current object and the interaction object move, to obtain a target video formed by a plurality of frames of target group photo comprising the first virtual image and the second virtual image that synchronously move; or
displaying a virtual image group photo entrance on an information page of a current account; displaying at least one group photo template corresponding to the virtual image group photo in response to a trigger operation for the virtual image group photo entrance; and displaying a selected target group photo template in a group photo preview region in response to a template selection operation, the target group photo template comprising the first bearing position and the at least one second bearing position.

18. The method according to claim 1, wherein displaying the target group photo template comprising the first bearing position and the at least one second bearing position comprises:
displaying a target group photo template with a default background, the target group photo template comprising the first bearing position and the at least one second bearing position; and
the method further comprises:
displaying a background changing control corresponding to the target group photo template, the background changing control being configured to change the background of the target group photo template; and
changing, in response to a background changing operation triggered based on the background changing control, the background of the target group photo template from the default background to a target background indicated in the background changing operation for changing,
wherein the method further comprises:
displaying a background preview interface in response to a trigger operation for the background changing control, and displaying a generated target background in the background preview interface, the target background corresponding to the current object and the interaction object; and
receiving the background changing operation in response to a confirmation operation for the target background, the background changing operation instructing to change the background of the target group photo template from the default background to the target background.

19. An electronic device comprising one or more processors and a memory containing a computer program that, when being executed, causes the one or more processors to perform:
displaying a target group photo template comprising a first bearing position and at least one second bearing position, the first bearing position bearing a first virtual image corresponding to a current object, and the second bearing position being configured for bearing a virtual image corresponding to an invited interaction object;
displaying, in response to an information editing operation triggered based on the target group photo template, impression information edited for the interaction object, the impression information being configured for indicating an impression of the current object for the interaction object;
transmitting, in response to a group photo invitation operation for the interaction object, a group photo invitation bearing the impression information to a terminal corresponding to the interaction object; and
displaying a second virtual image at a second bearing position in the target group photo template when the interaction object responds to the group photo invitation based on the impression information, and obtaining a target group photo comprising the first virtual image and the second virtual image.

20. A non-transitory computer readable storage medium containing a computer program that, when being executed, causes at least one processor to perform:
displaying a target group photo template comprising a first bearing position and at least one second bearing position, the first bearing position bearing a first virtual image corresponding to a current object, and the second bearing position being configured for bearing a virtual image corresponding to an invited interaction object;
displaying, in response to an information editing operation triggered based on the target group photo template, impression information edited for the interaction object, the impression information being configured for indicating an impression of the current object for the interaction object;
transmitting, in response to a group photo invitation operation for the interaction object, a group photo invitation bearing the impression information to a terminal corresponding to the interaction object; and
displaying a second virtual image at a second bearing position in the target group photo template when the interaction object responds to the group photo invitation based on the impression information, and obtaining a target group photo comprising the first virtual image and the second virtual image.
